(19) United States
(12) Patent Application Publication
(10) Pub. No.: US 2026/0128689 A1
(43) Pub. Date: May 7, 2026

(54) METHOD AND SYSTEM FOR ELECTRIC POWER GENERATION FROM EARTH'S ROTATION THROUGH ITS OWN MAGNETIC FIELD

(71) Applicants: Christopher F. Chyba, Princeton, NJ (US); Kevin P. Hand, Los Angeles, CA (US); Thomas H. Chyba, Tijeras, NM (US)

(72) Inventors: Christopher F. Chyba, Princeton, NJ (US); Kevin P. Hand, Los Angeles, CA (US); Thomas H. Chyba, Tijeras, NM (US)

(21) Appl. No.: 19/320,407

(22) Filed: Sep. 5, 2025

Related U.S. Application Data
(60) Provisional application No. 63/716,866, filed on Nov. 6, 2024.

(51) Int. Cl. H02N 11/00; G05B 15/02; H01F 1/20

(52) U.S. Cl. CPC H02N 11/002; G05B 15/02; H01F 1/20

(57) ABSTRACT

In various aspects, a power-generating device is provided. The power-generating device may include a three-dimensional structure. The three-dimensional structure may be composed of a conductive material having (i) a magnetically permeable material having a topology that alters Earth's magnetic field such that curl (v×B)≠0, where v is Earth's velocity of rotation and B is the component of Earth's magnetic flux density symmetric about Earth's axis of rotation and (ii) a magnetic Reynolds number less than ten (Rₘ<10). The three-dimensional structure may be configured to generate power and heat when carried with Earth's rotation via Earth's axially symmetric non-rotating magnetic field.

### CROSS-REFERENCE TO RELATED APPLICATIONS

The present application claims priority to U.S. provisional application No. 63/716,866 filed Nov. 6, 2024, the entirety of which is incorporated by reference herein.

### TECHNICAL FIELD

The present disclosure is drawn to devices, systems, and methods for the generation of electric power from Earth's rotation through its own magnetic field.

### BACKGROUND

This section is intended to introduce the reader to various aspects of the art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

It has been theoretically demonstrated that electricity could be generated from Earth's rotation through its own magnetic field, provided certain topological and material conditions are met by an appropriate device. However, since Faraday's early experiments in the 19^{th} century, the prevailing belief has been that it is not possible to generate electricity from Earth's rotation through its own magnetic field. It was thought that this impossibility had been both theoretically and experimentally demonstrated. But the underlying assumptions associated with this prevailing belief may be circumvented via the proper material and topologies. Suitable power devices when scaled may allow for power generation for individual homes as well as generation in power plants that can feed the overall electrical power grid. They may also be useful in smaller, more specialized contexts.

### BRIEF SUMMARY

Various deficiencies in the prior art are addressed below by the disclosed systems, methods, and devices for the generation of power using Earth's rotation through its own magnetic field.

In various aspects, a power-generating device may be provided. The power-generating device may include a three-dimensional structure. The three-dimensional structure may be composed of a conductive material having (i) a magnetically permeable material having a topology that alters Earth's magnetic field such that curl (v×B)≠0, where v is Earth's velocity of rotation and B is the component of Earth's magnetic flux density symmetric about Earth's axis of rotation and (ii) a magnetic Reynolds number less than ten (Rₘ<10). The three-dimensional structure may be configured to generate power and heat when carried with Earth's rotation via Earth's axially symmetric non-rotating magnetic field.

In some embodiments, the conductive material may be a single homogeneous structure (e.g., the conductive material having the magnetically permeable material and magnetic Reynolds number less than 10 may be a single material).

In some embodiments, the conductive material may be a non-homogeneous structure (e.g., the conductive material may include two separated components). The non-homogeneous structure may include a first component. The first component may be a material having the magnetically permeable material having a topology that alters Earth's magnetic field such that curl (v×B)≠0, where v is Earth's velocity of rotation and B is the component of Earth's magnetic flux density symmetric about Earth's axis of rotation. The second component may be a material that has a magnetic Reynolds number less than ten (Rₘ<10). The second component may be disposed around the first component, for example, as a wrapper or a thin coating.

In some embodiments, the three-dimensional structure may be substantially ellipsoidal (e.g., spherical). In some embodiments, the three-dimensional structure may be substantially cylindrical. In some embodiments, the three-dimensional structure may be substantially that of a polygonal prism. In some embodiments, the three-dimensional structure may be irregular.

In some embodiments, the second component may be a coating on the three-dimensional structure. In some embodiments, the second component may be a wrapper disposed circumferentially around the three-dimensional structure. In some embodiments, a conductivity and magnetic permeability of the second component may be different from a conductivity and magnetic permeability of the first component.

In some embodiments, the power-generating device may further include a metallic material embedded into the three-dimensional structure. The metallic material may form a conducting path.

In some embodiments, the three-dimensional structure may form a cylindrical shell having an inner radius a and an outer radius b. In some embodiments, the ratio of the outer radius to the inner radius may be between 1-10⁶.

In some embodiments, a relative magnetic permeability of the device may be between 1 and 10⁸. An electrical conductivity of the device may be between 10⁻³ and 10⁸ S m⁻¹.

In some embodiments, the conductive material may be MnZn ferrite. The conductive material may be NiZn ferrite. In some embodiments, the conductive material may be a permalloy or other magnetic composite. The conductive material may be a mu-metal. The conductive material may be nickel or iron. The conductive material may be an alloy of magnetically permeable metals (e.g., steel). The conductive material may be a soft-magnetic powder made of iron with other materials, including possibly insulating materials.

In some embodiments, the first component may be a mu-metal. The first component may be iron. The first component may be nickel. The first component may be an alloy of magnetically permeable metals (e.g., steel). The first component may be a nickel-iron alloy (e.g., permalloy). The first component may be a soft-magnetic powder made of iron with other materials, including possible insulating materials.

In some embodiments, the second component may be graphite. The second component may be germanium. The second component may be a metal or metallic alloy.

In some embodiments, the three-dimensional structure may be oriented orthogonal to the Earth's magnetic field component that is symmetric about Earth's rotation axis. In some embodiments, the three-dimensional structure may be oriented non-orthogonal to the Earth's magnetic field component that is symmetric about Earth's rotation axis. The three-dimensional structure may be oriented orthogonal to the direction of Earth's velocity of rotation. The three-dimensional structure may be disposed greater than 100 km from Earth's surface. The three-dimensional structure may be disposed underneath or at the surface of Earth's oceans or other body of water, or underground.

In some embodiments, the power-generating device may include a third component. The third component may include an additional magnetically permeable material. The magnetically permeable material may be configured to channel Earth's magnetic field.

According to various aspects of the present disclosure, a method for electric power generation may be provided. The method may include providing a power-generating device as described herein. The method may also include positioning the power-generating device at least partially orthogonal to Earth's magnetic field component that is symmetric about Earth's axis of rotation. The method may also include allowing the power-generating device to be carried with the Earth's rotation causing the power-generating device to generate power via Earth's axially symmetric non-rotating magnetic field.

In some embodiments, the method may further include electrically coupling the power-generating device to an electric storage device or a power-consuming apparatus. In some embodiments, the power-generating device may be disposed in an orbiting satellite.

According to various aspects of the present disclosure, a system may be provided. The system may include a power-generating device as described herein. The system may also include means for storing electricity operably coupled to the power-generating device.

In some embodiments, the system may further include a plurality of power-generating devices. The plurality of power-generating devices may be oriented along multiple axes configured to continuously generate power. The power-generating device may further include a third component. The third component may include an additional magnetically permeable material configured to channel Earth's magnetic field.

According to various aspects of the present disclosure, a system may be provided. The system may include a plurality of power-generating devices as disclosed herein. Each of the plurality of power-generating devices may be submerged in a coolant. The plurality of power-generating devices may be configured to heat the coolant as the plurality of power-generating devices are carried with Earth's rotation. The system may also include at least one turbine disposed external to the coolant. The at least one turbine may be configured to be turned by generated steam.

In some embodiments, steam may be provided by the coolant. The steam may drive the at least one turbine.

In some embodiments, the system may further include a secondary circuit. The secondary circuit may include a liquid. The liquid may be configured to absorb heat from the coolant and produce steam when heated. The steam may drive the at least one turbine.

In some embodiments, the coolant may be water. In some embodiments, the coolant may be carbon dioxide. In some embodiments, the coolant may be a liquid metal. In some embodiments the coolant may be liquid sodium. In some embodiments, the coolant may be helium. The coolant may be liquid nitrogen or helium.

In some embodiments, at least one of the three-dimensional structures of at least one of the plurality of power-generating devices may be substantially cylindrical. In some embodiments, at least one of the three-dimensional structures of at least one of the plurality of power-generating devices may be substantially ellipsoidal. In some embodiments, at least one of the three-dimensional structures of at least one of the plurality of power-generating devices may be substantially a polygonal prism. In some embodiments, at least one of the three-dimensional structures of at least one of the plurality of power-generating devices may be substantially irregular.

In some embodiments, the plurality of power-generating devices may be oriented along multiple axes and configured to continuously generate power. In some embodiments, the plurality of power-generating devices may further include a third component. The third component may include an additional magnetically permeable material and may be configured to channel Earth's magnetic field.

According to various aspects of the present disclosure, a method for generating power may be provided. The method may include providing a plurality of power-generating devices as described herein. The method may also include submerging the plurality of power-generating devices into the coolant. The method may also include allowing the plurality of power-generating devices to be carried with the Earth's rotation, causing the power-generating devices to heat the coolant and produce steam. The method may also include allowing the steam to turn at least one turbine.

In some embodiments, the method may further include transferring the heat to a secondary circuit. The secondary circuit may include liquid. Transferring the heat to the secondary circuit may cause the liquid to produce steam and turn the at least one turbine.

According to various aspects of the present disclosure, a method for generating power may be provided. The method may include providing a plurality of power-generating devices of claim 1 connected in a combination of series and parallel. The method may include allowing the plurality of power-generating devices to be carried with Earth's rotation causing the plurality of power-generating devices to produce direct-current electricity.

According to various aspects of the present disclosure, a system may be provided. The system may include at least one power-generating device as described herein. The power-generating device may be electrically coupled to at least one power-consuming apparatus.

According to various aspects of the present disclosure, a system may be provided. The system may include at least one power-generating device as described herein. The power-generating device may be thermally coupled to at least one device configured to convert thermal energy to electricity.

In some embodiments, the at least one device may be a solid-state device. The at least one device may be a non-solid-state device. The three-dimensional structure of the at least one power-generating device may be a cylindrical shell having an inner radius a and outer radius b. The ratio of the outer radii to the inner radii may be between 1-10⁶.

Additional objects, advantages, and features of the present disclosure will be set forth in part in the description which follows, and in part will become apparent to those skilled in the art upon examination of the following or may be learned by practice of the present disclosure. The objects and advantages of the present disclosure may be realized and attained by means of the instrumentalities and combinations particularly pointed out in the appended claims.

### BRIEF DESCRIPTION OF FIGURES

The accompanying drawings, which are incorporated in and constitute a part of this specification, illustrate embodiments of the present disclosure and, together with a general description of the present disclosure given above, and a detailed description of the embodiments given below, serve to explain the principles of the present disclosure.

FIG. 1 shows a depiction of an embodiment of a cylindrical power-generating device.

FIG. 2A shows a depiction of an embodiment of an ellipsoidal power-generating device.

FIG. 2B shows a depiction of an embodiment of a cuboid power-generating device.

FIG. 3 shows a depiction of a flow diagram of an embodiment of a method for electric power generation.

FIG. 4 shows a depiction of an embodiment of a system.

FIG. 5 shows a depiction of an embodiment of a system.

FIG. 6 shows a depiction of a flow diagram of an embodiment of a method for electric power generation.

FIG. 7 shows a depiction of an experimental configuration of an embodiment of a power-generating device.

FIG. 8 shows a depiction of a graphical prediction of emf behavior for a low-Rₘ magnetically permeable cylindrical shell.

FIG. 9 shows a depiction of graphical results for measured emf behavior for a low-Rₘ magnetically permeable cylindrical shell.

FIG. 10 shows a depiction of graphical experimental results for emf behavior of a low-Rₘ magnetically permeable solid cylinder.

FIG. 11 shows a depiction of measured current behavior of a low-Rₘ magnetically permeable cylindrical shell.

FIG. 12 shows a depiction of a graphical comparison of the combined data for two orientations of a cylindrical shell compared with the combined data for four orientations of a solid cylinder.

FIG. 13 shows a depiction of measured emf behavior for a low-Rₘ magnetically permeable cylindrical shell at an alternate test site.

It should be understood that the appended drawings are not necessarily to scale, presenting a somewhat simplified representation of various features illustrative of the basic principles of the present disclosure. The specific design features of the sequence of operations as disclosed herein, including for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following drawings merely illustrate the principles of the present disclosure. It will thus be appreciated that those skilled in the art will be able to devise various arrangements that, although not explicitly described or shown herein, embody the principles of the present disclosure and are included within its scope. Furthermore, all examples recited herein are principally intended expressly to be only for illustrative purposes to aid the reader in understanding the principles of the present disclosure and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the claims. Moreover, some statements may apply to some inventive features but not to others. Those skilled in the art and informed by the teachings herein will realize that the present disclosure is also applicable to various other technical areas or embodiments.

Earth rotates through the axisymmetric part of its own magnetic field, but a simple proof shows that it is impossible to use this to generate electricity in a conductor rotating with Earth. However, it has been shown that the assumptions underlying this proof could theoretically be violated and the proof circumvented. This requires a soft magnetic material with a topology satisfying a particular mathematical condition and a composition and scale favoring magnetic diffusion, i.e., having a low magnetic Reynolds number Rₘ. One such realization of these requirements may include a cylindrical shell formed by manganese-zinc ferrite.

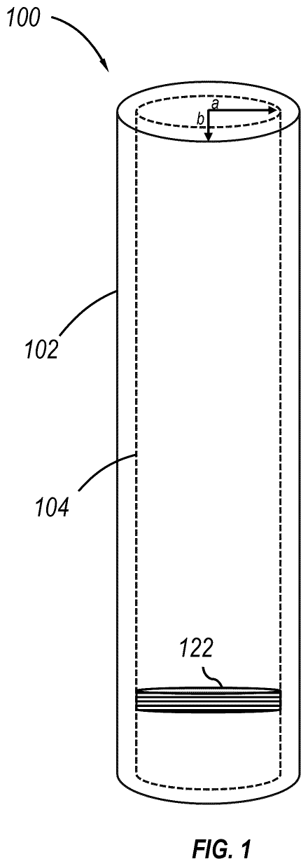

In various aspects, a power-generating device may be provided. Referring to FIG. 1, an embodiment of a power-generating device (100) is shown. The power-generating device may include a three-dimensional structure composed of a conductive material having (i) a magnetically permeable material having a topology that alters Earth's magnetic field such that curl (v×B)≠0, where v is Earth's velocity of rotation and B is the component of Earth's magnetic flux density symmetric about Earth's axis of rotation and (ii) a magnetic Reynolds number less than 10 (Rₘ<10). The three-dimensional structure may be configured to generate power and heat when carried with Earth's rotation via Earth's axially symmetric non-rotating field.

In the embodiment shown in FIG. 1, the power-generating device is a magnetically permeable hollow cylinder of interior radius a (giving the interior surface (104)) and exterior radius b (forming the exterior surface (102)). In some embodiments, the interior surface and exterior surface may be a supporting structure. Non-limiting examples of the supporting structures may include, e.g., wood, a polycarbonate or polyvinyl chloride. The conductive material may be present as a coating or film on the supporting structure. The supporting structure may have a conductivity and magnetic permeability different from the conductive material. In some embodiments, the supporting structure (e.g., the interior and/or exterior surface) may comprise the conductive material.

In some embodiments, the conductive material may form a single homogenous structure. For example, the conductive material may be an alloyed metal forming a magnetically permeable material having a topology that alters Earth's magnetic field such that curl (v×B)≠0 with a magnetic Reynolds number less than ten (Rₘ<10). In some embodiments, the conductive material may be a composite material. The composite material may be formed by the material having the magnetically permeable material, embedded in a matrix with a material having a magnetic Reynolds number less than ten. Additionally, the single homogeneous structure may be formed by solid-state processing (e.g., powder metallurgy or diffusion bonding). In some embodiments, the homogeneous material may be formed by nanostructuring. For instance, advanced fabrication techniques may allow for nanostructured integration of various materials.

In some embodiments, the conductive material may be a non-homogeneous structure. The non-homogeneous structure may be formed by a first component and a second component. The first component may include the magnetically permeable material. The second component may include a material having a magnetic Reynolds number less than ten. In some embodiments, the first component and second component may be separate materials. For example, the second component may be applied to the first component as a coating. In another example, the second component may be applied to the first component via, e.g., cold spray processing. In some embodiments, where the first component forms the three-dimensional structure, the second component may be a wrapper disposed circumferentially around the first component.

In some embodiments, the second component may have a conductivity and magnetic permeability different from the first component. In some embodiments, the second component might itself not be magnetically permeable, but would be electrically conducting. In some embodiments there may be electrically insulating layers between the first and second component.

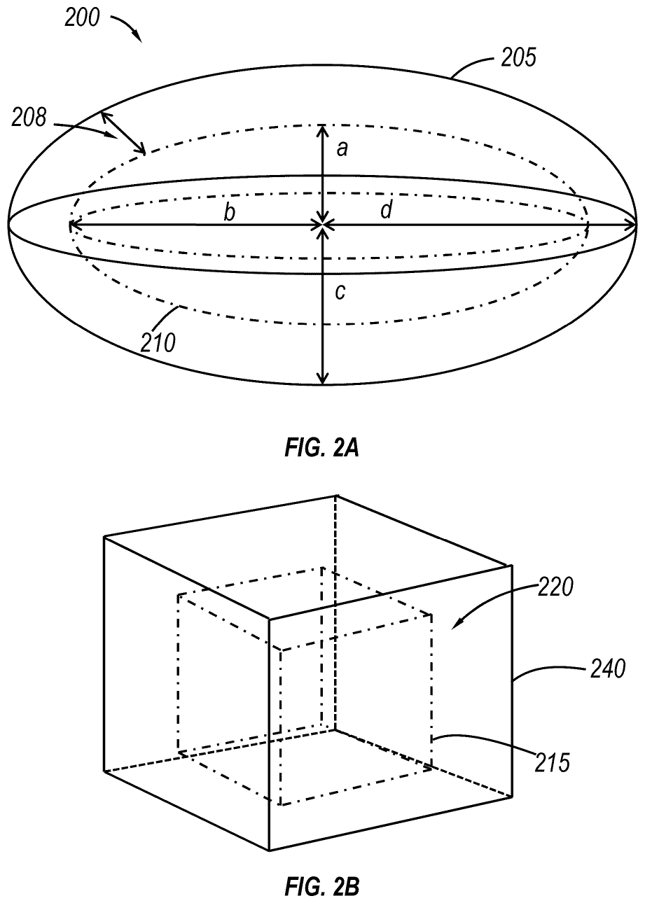

Referring now to FIG. 2, in some embodiments, the three-dimensional structure may be a substantially ellipsoidal shell (200) having an interior ellipsoidal boundary (210) and exterior ellipsoidal boundary (205). In embodiments where the conductive material forms a homogeneous structure, the ellipsoidal shell (200) may be formed by the conductive material while the interior ellipsoid may be hollow or formed by a supporting structure (e.g., wood or a polyvinyl chloride).

In certain embodiments, where the conductive material exhibits a non-homogeneous structure, wherein the interior ellipsoid is formed from the first component and the exterior ellipsoid from the second component, the gap (208) between these ellipsoids may be minimal-on the order of microns-such that the exterior ellipsoid functions as a wrapper circumferentially disposed around the interior ellipsoid.

Still referring to FIG. 2A, the semi-major axis of the exterior ellipsoid d may be greater than the semi-minor axis of the exterior ellipsoid c. In some embodiments, the semi-major axis of the exterior and interior ellipsoid d, b may be less than the semi-minor axis of the exterior and interior ellipsoid c, a. In some embodiments, c, a may equal d, b, i.e., the ellipsoid may form a sphere. In some embodiments, the three-dimensional structure may be substantially cylindrical (see e.g., FIG. 1).

In some embodiments, the three-dimensional structure may be substantially that of a polygonal prism. For example, as shown in FIG. 2B the polygonal prism may be a rectangular prism (FIG. 2B shows the special case where the rectangular prism is a cuboid). The polygonal prism may be a trapezoidal prism. The polygonal prism may be a cube. The polygonal prism may be a parallelogram-based prism. In some embodiments, the three-dimensional structure may be irregular in shape. The three-dimensional structure may be hollow. For example, in embodiments where the three-dimensional structure is substantially cylindrical, the cylinder may be hollow and thus forms a cylindrical shell. Alternatively, the three-dimensional structure may also be solid. In still other embodiments, the three-dimensional structure may include both hollow and solid portions. For example, the three-dimensional structure may include one or more segments inside the three-dimensional structure. The one or more segments may include both hollow and solid portions.

Still referring to FIG. 2B, the polygonal prism may include an outer shell (240). The outer shell may define an internal volume of space (220). In some embodiments, the polygonal prism may include an inner shell (215) disposed in the internal volume of space.

Referring again to FIG. 1, in some embodiments, the power-generating device may further include a metallic material (122) embedded into the three-dimensional structure. The metallic material may be configured to capture a particular current path around the three-dimensional structure.

Still referring to FIG. 1, the three-dimensional structure may form a cylindrical shell having an inner radius a and an outer radius b. In some embodiments, the ratio of the outer radius to the inner radius may be between about 1-10⁶. In some embodiments, the ratio of the outer radius to the inner radius may be between about 1-10⁴. In some embodiments, the ratio of the outer radius to the inner radius may be between about 1-8. In some embodiments, the ratio of the outer radius to inner radius may be between about 1-5. In some embodiments, the ratio of the outer radius to the inner radius may be between about 1-2.

In some embodiments, a relative magnetic permeability of the device may be between about 1 and 10⁸. In some embodiments, the relative magnetic permeability of the device may be between about 1 and 10⁶. The relative magnetic permeability of the device may be between about 1 and 10⁵. The relative magnetic permeability of the device may be between about 1 and 10⁴. The relative magnetic permeability of the device may be between about 1 and 10³. The relative magnetic permeability of the device may be between about 1 and 100.

In some embodiments, an electrical conductivity of the device may be between about 10⁻³ and 10⁸ S m⁻¹. An electrical conductivity of the device may be between about 10⁻¹ and 10⁶ S m⁻¹. An electrical conductivity of the device may be between about 10 and 10⁴ S m⁻¹.

In some embodiments, the conductive material may be MnZn ferrite. The conductive material may be NiZn ferrite. In some embodiments, the conductive material may be a permalloy or other magnetic composite. The conductive material may be a mu-metal. The conductive material may be nickel or iron. The conductive material may be an alloy of magnetically permeable metals. In some embodiments, the alloy of magnetically permeable metals may be steel. The conductive material may be a soft-magnetic powder made of iron with other materials, including possible insulating materials.

In some embodiments, the first component may be a mu-metal. The first component may be iron. The first component may be nickel. The first component may be an alloy of magnetically permeable metals (e.g., steel). The first component may be a nickel-iron alloy (e.g., permalloy). The first component may be a soft-magnetic powder made of iron with other materials, including possible insulating materials.

In some embodiments, the second component may be graphite. The second component may be germanium. The second component may be a metal or metallic alloy.

In some embodiments, the three-dimensional structure may be oriented orthogonal to the Earth's magnetic field component that is symmetric about Earth's rotation axis. In some embodiments, the three-dimensional structure may be oriented non-orthogonal to the Earth's magnetic field component that is symmetric about Earth's rotation axis. For example, the three-dimensional structure may be oriented about 10 degrees offset from the orthogonal orientation. In some embodiments, the three-dimensional structure may be oriented about 20 degrees offset from the orthogonal orientation. In some embodiments, the three-dimensional structure may be oriented about 30 degrees offset from the orthogonal orientation. In some embodiments, the three-dimensional structure may be oriented about 40 degrees offset from the orthogonal orientation. The three-dimensional structure is preferably oriented orthogonal to Earth's magnetic field.

The three-dimensional structure may be oriented orthogonal to the direction of Earth's velocity of rotation. The three-dimensional structure may be disposed greater than 100 km from Earth's surface. For example, the three-dimensional structure may be utilized to generate power in an orbiting space station and/or satellite. Alternatively, the three-dimensional structure may be disposed underneath or at the surface of Earth's oceans or other body of water, or underground. For example, the three-dimensional structure may be utilized to generate power in a submarine vessel.

In some embodiments, the power-generating device may include a third component. The third component may include an additional magnetically permeable material. The magnetically permeable material may be configured to channel Earth's magnetic field.

In some embodiments, there may be separate objects arranged along independent axes, perhaps orthogonal to one another, so that whichever way the total configuration was rotated, some components would have roughly the proper orientation relative to Earth's geomagnetic field and direction of rotation.

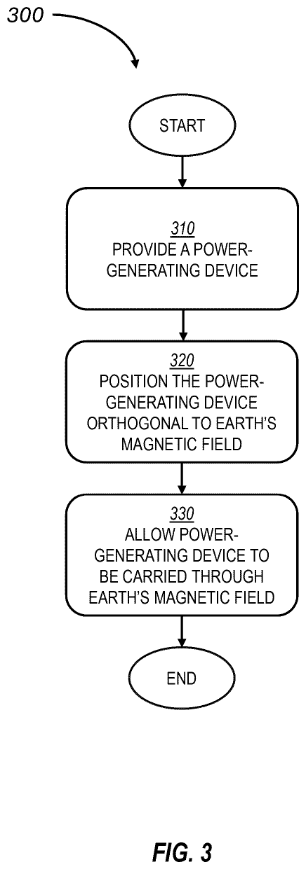

According to various aspects of the present disclosure, a method (300) for electric power generation may be provided. Referring to FIG. 3, the method may include providing (310) a power-generating device as described herein. The method may also include positioning (320) the power-generating device orthogonal to Earth's magnetic field component that is symmetric about Earth's axis of rotation. The method may also include allowing (330) the power-generating device to be carried with the Earth's rotation causing the power-generating device to generate power via Earth's axially symmetric non-rotating magnetic field.

In some embodiments, the method may further include electrically coupling the power-generating device to an electric storage device and/or a power consuming apparatus. For example, the power-generating device may be used to charge a cellular device or power a radio. In some embodiments, the power-generating device may be disposed in an orbiting satellite.

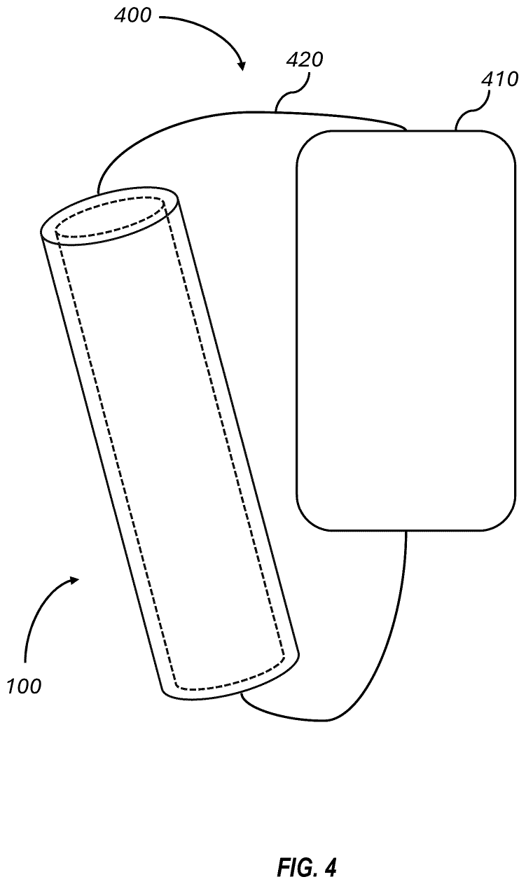

Referring to FIG. 4, an embodiment of a system (400) is shown. The system may include a power-generating device (100) as described herein. The system may also include means for storing electricity (410). The means for storing electricity may include for example, a battery, a plurality of batteries, ultracapacitor(s), and/or flywheel(s). The means for storing electricity may be operably coupled to the power-generating device. For example, the means for storing electricity may be operably coupled to the power-generating device via e.g., conducting wires (420). Those skilled in the art and informed by the teachings herein will appreciate that other connections may also be suitable. For example, alternative coupling mechanisms may include inductive or wireless energy transfer systems, allowing the means for storing electricity to receive power without direct physical connections. Additionally, power conversion or regulation circuits may be incorporated to optimize the efficiency of energy transfer between the power-generating device and the storage means. Those skilled in the art will further recognize that the system may integrate monitoring and control components to regulate the transfer of power from the power-generating device to the means for storing electricity.

In some embodiments, the system may further include a plurality of power-generating devices. The plurality of power-generating devices may be oriented along multiple axes configured to continuously generate power. For example, the system may include a first, second, and third power-generating devices. The first power-generating device may be oriented orthogonal to Earth's magnetic field. The second power-generating device may be oriented 10 degrees offset from orthogonal to Earth's magnetic field. The third power-generating device may be oriented 20 degrees offset from orthogonal to Earth's magnetic field.

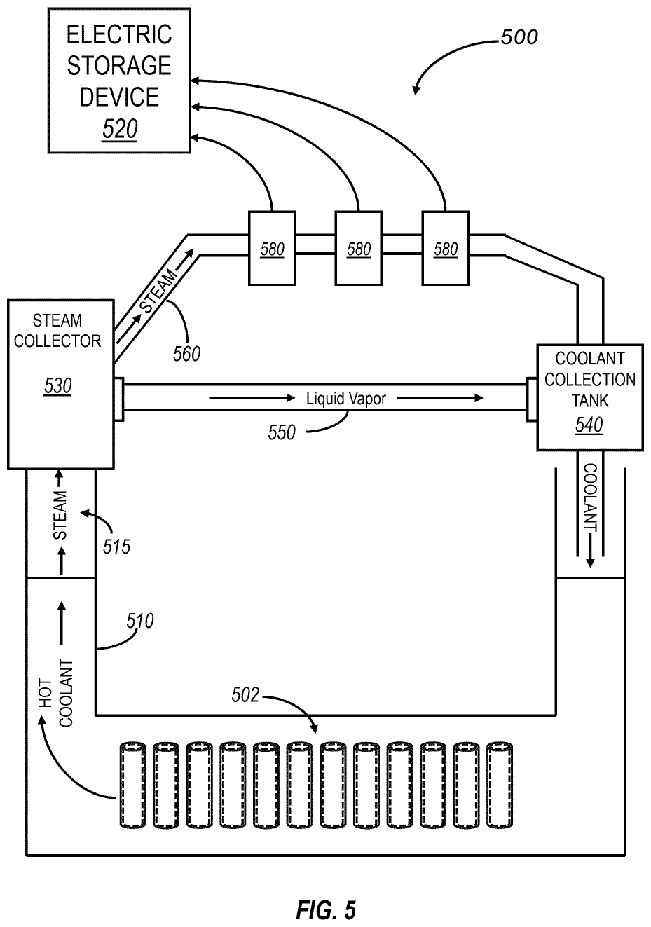

Referring to FIG. 5, a schematic of an embodiment of a system (500) is shown. The system may include a plurality of power-generating devices (502) as disclosed herein. As shown in FIG. 5, the plurality of power-generating devices may each have the same orientation (e.g., orthogonal to Earth's magnetic field). In some embodiments, at least one of the plurality of power-generating devices may have an orientation different from at least one other power-generating device. In some embodiments, each power-generating device may comprise a same three-dimensional geometric shape. For example, as FIG. 5 shows, each power-generating device may be substantially cylindrical. In other embodiments, the plurality of power-generating devices may include at least two three-dimensional geometric shapes. For example, the plurality of power-generating devices may include a combination of cylindrical, ellipsoid, or polygonal shaped devices.

The system may include a storage tank (510). The storage tank may contain a coolant. Each of the plurality of power-generating devices may be submerged in the coolant. In some embodiments, the chamber containing the power-generating devices and the coolant may be a high-pressure chamber. As shown in FIG. 5, the power-generating devices may be completely submerged in the coolant. However, one skilled in the art would recognize that the plurality of power-generating devices may only be partially submerged in the coolant.

The storage tank may include one or more channels (515). The one or more channels may be configured to direct steam towards a steam collector (530). The steam collector may be operably coupled to a liquid channel (550) and a steam channel (560). The liquid channel may be configured to recycle cooled liquid vapor back into the storage tank via one or more channels and/or a coolant collection tank (540).

The system may include at least one turbine. As shown in FIG. 5, the system may include one or more turbines (580). The one or more turbines may be operably coupled to an electric storage device (520), or it may feed directly into an electric grid for transmitting electrical power. The one or more turbines may be configured to be turned by the steam. For example, as steam passes through the steam channel the steam may turn the one or more turbines.

As shown in FIG. 5, the plurality of power-generating devices may be arranged in a row configuration. It is also envisioned that the plurality of power-generating devices may be stacked in columns. In some embodiments, the devices may be arranged according to other geometries.

The plurality of power-generating devices may be configured to heat the coolant as the plurality of power-generating devices are carried with Earth's rotation. The system may also include at least one turbine disposed external to the coolant. The at least one turbine may be configured to be turned by generated steam.

In some embodiments, steam may be provided by the coolant. The steam may drive the at least one turbine.

In some embodiments, the system may further include a secondary circuit. The secondary circuit may include a liquid. The liquid may be configured to absorb heat from the coolant and produce steam when heated. The steam may drive the at least one turbine.

In some embodiments, the coolant may be water. In some embodiments, the coolant may be carbon dioxide. In some embodiments, the coolant may be liquid sodium, or a liquid metal. In some embodiments, the coolant may be helium. The coolant may be liquid nitrogen.

In some embodiments, at least one of the three-dimensional structures of at least one of the plurality of power-generating devices may be substantially cylindrical. In some embodiments, at least one of the three-dimensional structures of at least one of the plurality of power-generating devices may be substantially ellipsoidal. In some embodiments, at least one of the three-dimensional structures of at least one of the plurality of power-generating devices may be substantially a polygonal prism.

In some embodiments, the plurality of power-generating devices may be oriented along multiple axes and configured to continuously generate power. In some embodiments, the plurality of power-generating devices may further include a third component. The third component may include an additional magnetically permeable material and may be configured to channel Earth's magnetic field.

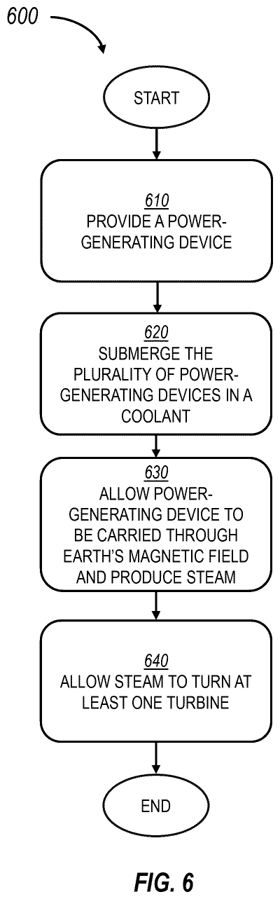

According to various aspects of the present disclosure, a method for generating power may be provided. Referring to FIG. 6, the method may include providing (610) a plurality of power-generating devices as described herein. The method may also include submerging (620) the plurality of power-generating devices into the coolant. The method may also include allowing (630) the plurality of power-generating devices to be carried with the Earth's rotation, causing the power-generating devices to heat the coolant and produce steam. The method may also include allowing (640) the steam to turn at least one turbine.

In some embodiments, the method may further include transferring the heat to a secondary circuit. The secondary circuit may include liquid. Transferring the heat to the secondary circuit may cause the liquid to produce steam and turn the at least one turbine.

In some embodiments, the method may further include situating the power-generating devices and coolant in a pressure chamber.

According to various aspects of the present disclosure, a system may be provided. The system may include at least one power-generating device as described herein. The power-generating device may be electrically coupled to at least one power-consuming apparatus.

According to various aspects of the present disclosure, a method for generating power may be provided. The method may include providing a plurality of power-generating devices of claim 1 connected in a combination of series and parallel. The method may include allowing the plurality of power-generating devices to be carried with Earth's rotation causing the plurality of power-generating devices to produce direct-current electricity.

According to various aspects of the present disclosure, a system may be provided. The system may include at least one power-generating device as described herein. The power-generating device may be thermally coupled to at least one device configured to convert thermal energy to electricity.

In some embodiments, the at least one device may be a solid-state device. For example, the solid-state device may be a thermoelectric (Seebeck) generator or thermophotovoltaic (TPV) generator. In some embodiments, the at least one device may be a non-solid-state device. For example, the non-solid-state device may be at least one of a Stirling engine, a Brayton cycle engine, a Rankine Cycle engine, a thermoacoustic engine, or a Fluidyne engine.

In some embodiments, the at least one device may be a solid-state device. The at least one device may be a non-solid-state device. The three-dimensional structure of the at least one power-generating device may be a cylindrical shell having an inner radius a and outer radius b. The ratio of the outer radii to the inner radii may be between 1-10⁶.

The following description serves to illustrate the principles of the present disclosure. The description is provided to aid the reader in understanding the various techniques outlined herein. Also, the following description includes mathematical and experimental evidence of the various techniques outlined herein. Those skilled in the art and informed by the teachings herein will realize some statements may apply to some features but not to others.

### A. Earth's Geomagnetic Field

Controlling for thermoelectric and other potentially confounding effects (including 60 Hz and RF background), it is shown that a small demonstration system may generate a continuous DC voltage and current of the (low) predicted magnitude. Other predictions of the theory are tested and verified herein: voltage and current peak when the cylindrical shell's long axis is orthogonal to both Earth's rotational velocity v and magnetic field; voltage and current go to zero when the entire apparatus (cylindrical shell together with current leads and multimeters) is rotated 90° to orient the shell parallel to v; voltage and current again reach a maximum but of opposite sign when the apparatus is rotated a further 90°; an otherwise-identical solid MnZn ferrite cylinder generates zero voltage at all orientations; and a high-Rₘ cylindrical shell produces zero voltage. The effect is also reproduced at a second experimental location. The purpose of these experiments was to test the existence of the predicted effect.

Could electricity be generated from Earth's rotation through its own magnetic field? This question has been asked at least since Faraday's first experiments testing the idea in January 1832 gave a negative result, and the answer, for obvious reasons reviewed below, has since seemed to remain obviously no.

But its recently been shown theoretically that for a system satisfying specific topological and material conditions the answer could be yes. Here experimental results for a small demonstration laboratory system that generates a low continuous DC voltage and current that behave according to that prediction are shown. The intention of these experiments was to test the existence of the predicted effect, and the results and multiple controls reported here appear to demonstrate its reality. Ways in which this effect might be scaled to generate higher voltage and current are proposed but will be the subject of subsequent investigations.

Historical experiments relevant to this question are briefly discussed herein and these results are cast in a modern understanding of electromagnetism while providing a few necessary definitions. The physics is then reviewed that, surprisingly, makes the generation of electricity from Earth's rotation through its own field possible. The conditions required for a system to generate a continuous DC voltage as Earth carries that system through its magnetic field are also determined. Specific predictions for this system are derived (both in voltage and current magnitude and behavior under rotation), the experimental materials and method described, and the experimental results compared with the predictions. A discussion of controls and how possible confounding effects are provided. Finally, previous experiments and objections are reviewed, and a discussion of ways this effect might be scaled to generate higher voltage and current is provided.

Throughout the present disclosure, the concern is with conductors rotating with Earth's surface either through or along with components of Earth's magnetic field. To establish notation for this discussion, consider two reference frames, K and K′. K is an inertial frame with origin at Earth's center with the usual spherical coordinate (r, θ, φ); K moves with Earth in its orbit but does not rotate with the planet's polar (z-axis) rotation. The origins of K′ and K coincide, but K′ corotates with Earth at angular frequency ω=ω\hat{z}, so that a point fixed on Earth's surface does not change its coordinates in K′ over time. K′ is therefore the laboratory frame, and has coordinate (r, θ, φ) where φ′=φ−ωt for time t. Frames K and K′ are not exactly related by a Lorentz transformation because of Earth's rotation. In K′, Maxwell's equations incorporate rotation via the metric tensor g_{μv}, introducing factors

$$\sqrt{{g}_{00}} \approx 1 - \frac{1}{2} {( \frac{v}{c} )}^{2}$$

when (ν/c)<<1, where c is the speed of light. At velocities relevant to Earth's rotation (ν=354 ms⁻¹ at e.g., Princeton's latitude where the experiments were performed), electromagnetism in K′ behaves like that in an inertial frame to [symbol] (ν/c)² when (ν/c)˜10⁻¹². These corrections are negligible compared to the effects of interest here. One may therefore approximate K and K′ as two inertial frames in relative linear motion. It's henceforth assumed that (ν/c)²<<1 throughout this disclosure.

Detailed models of Earth's field derive it from a magnetic potential written in terms of surface harmonics and Schmidt-normalized associated Legendre polynomial with coefficients

$${g}_{l}^{m} and {h}_{l}^{m} .$$

A contemporary model carries terms up through degree l=13 and order m=12. Earth's tilted magnetic dipole can be resolved into components symmetric about Earth's rotation axis, and nonaxisymmetric components that depend on cos mφ′ and sin mφ′, where φ′ is the azimuthal angle (longitude) in K′ and m a whole number. The nonaxisymmetric components have order m≥1, whereas the symmetric components are of order m=0, In particular, the

$${g}_{1}^{0}$$

term corresponas to Earth's primary dipole axisymmetric about (and antiparallel to) Earth's rotation axis, and the leading off-axis terms

$${g}_{1}^{1} and {h}_{1}^{1}$$

corresponds to weaker dipoles lying 90° apart in Earth's equatorial plane and rotating with the planet.

Earth's axially symmetric dipole is given by

$${B}_{r}^{m = 0} = 2 {g}_{1}^{0} {( a / r )}^{3} cos θ \qquad ( 1 )$$

$${B}_{θ}^{m = 0} = {g}_{1}^{0} {( a / r )}^{3} sin θ$$

$${B}_{φ}^{m = 0} = 0$$

Where

$${g}_{1}^{0} = - 24496.5 nT ,$$

and the superscript “m=0” labels these as components of the axisymmetric field. Quadrupole, octupole, and higher degree axisymmetric terms enter with coefficients

$${g}_{2}^{0} = - 2396.6 nT , {g}_{3}^{0} = 1339.7 nT ,$$

and so on. Obviously, B^{m=0} has no q dependence for any degree l.

The lowest-degree nonaxisymmetric field is given by

$${B}_{r}^{m \neq 0} = 2 {( a / r )}^{3} ( {g}_{1}^{1} cos {φ}^{′} + {h}_{1}^{1} sin {φ}^{′} ) sin θ \qquad ( 2 )$$

$${B}_{θ}^{m \neq 0} = - {( a / r )}^{3} ( {g}_{1}^{1} cos {φ}^{′} + {h}_{1}^{1} sin {φ}^{′} ) cos θ$$

$${B}_{φ}^{m \neq 0} = {( a / r )}^{3} ( {g}_{1}^{1} sin {φ}^{′} - {h}_{1}^{1} cos {φ}^{′} )$$

Where

$${g}_{1}^{1} = - 1585.9 nT , {h}_{1}^{1} = 4945.1 nT ,$$

and the superscript “m≠0” labels these as components of the nonaxisymmetric field. Considering Eq. (2) in the θ=90° (equatorial) plane makes it evident that the

$${g}_{1}^{1} and {h}_{1}^{1}$$

terms have the form or dipoles oriented along the [symbol] and ŷ′ axes. Because φ′ denotes a longitude in K′, B^{m≠0} rotates in K with Earth at angular speed ω.

### Historical Background and Definitions

The behavior of conductors rotating through magnetic fields was the subject of considerable investigation during the nineteenth and early twentieth centuries. In 1852, Faraday experimented with a rotating conducting magnet connected to a galvanometer via contacts on the magnet's axle and rim. Current flowed when the magnet rotated around its north-south axis and the galvanometer part of the circuit (remained stationary, or when the magnet was stationary but the circuit rotated.

In modern terms, the conducting magnet rotates at velocity v through its own magnetic field H (where magnetic flux density B=μH and μ is magnetic permeability), producing a v×B field that generates an electromotive force (emf), driving a current. The emf & around a path C with line element dl moving with velocity v is:

$$ε = {∮}_{C} ( E + v \times B ) \cdot dl = {\int }_{S} [ - \partial B / \partial t + ∇ \times ( v \times B ) ] \cdot da \qquad ( 3 )$$

Where E is the electric field, B the magnetic flux density, and the area element da is right-hand normal to the surface S bounded by C. The second equality in Eq. (3) holds via Stokes' theorem provided there is no jump discontinuity on S. This will not be at issue for the experiments described below. The emf in K′ is the same as that in K provided that (v/c)²<<1.

Faraday interpreted his results to mean that magnetic fields do not rotate with a magnet when the magnet rotates around its symmetry axis. But others have shown that Faraday's results were equally well explained in a picture where the magnetic field does rotate with the magnet, and thereby produces a qv×B force on charges q in the stationary part of C, were v understood to mean the velocity of the rotating field. At the turn of the century, Poincaré concluded that since both the rotating and nonrotating field pictures appeared to give identical results, the distinction between them was “meaningless”.

Nonetheless, in 1912 open-circuit experiments settled the question. Experiments placed a cylindrical capacitor axially in the field of a solenoid (or, in another version of the experiment, in the field between two electromagnets capped with flat pole pieces), with a wire connecting the concentric cylinders of the capacitor. Corotation of the nested cylinders and their connecting wires, charges the cylinders due to the qv×B force on the wire; the wire may then be disconnected, the system despun, and an opposite charge on the cylinders measured. But it was shown that rotating the solenoid (or electromagnets) while holding the capacitor and connecting wire stationary did not charge the cylinders. These results have been reproduced, and it was shown that corotation of the capacitor and connecting wire together with the solenoid also charged the capacitor. These results proved that the field of a rotating axially symmetric electromagnet does not “rotate with the magnet,” a conclusion that is now a standard part of the electromagnetics literature. A subsequent attempted theoretical refutation of these results was shown to be incorrect due to calculational error.

Some authors have nonetheless argued that an axisymmetric field rotates with a permanent magnet. But even if this conclusion were correct, a permanent magnet cannot provide a model for Earth's deeply originating magnetic field, which is the field that concerns us here. Earth's field derives from an electromagnetic dynamo in Earth's liquid-iron outer core, which is at a depth of more than 2800 km. Iron's Curie temperature is reached at only ˜30 km depth, and Earth's magnetic field reversals are also inconsistent with a permanent magnet.

In the usual modern understanding of the Lorentz force F=q (E+v×B), the only relevant velocity v is the velocity of a charge q (or of a conductor, which provides a collection of charges) relative to a frame in which the magnetic flux density is B. The notion of a uniform field “moving” or “rotating” is regarded as incoherent. Nonuniform fields can of course translate (for example, a field displacing along with the moving magnet that generates it) or rotate, as with the m≠0 components of components of Earth's geomagnetic field, Eq. (2). This may introduce a time-varying B field, ∂B/∂t, in a particular frame, or correspondingly a term E=∂A/∂t in the Lorentz force law, but the velocity v in the v×B part of that law refers only to the velocity of the charge q in the frame under consideration, not a velocity relative to the translating or rotating magnetic field.

Lorentz Force for m=0 and m≠0 Components of Earth's Field

Consider a test charge q corotating with Earth at a constant velocity v=rω sin θ\hat{φ} as viewed in reference frame K. One may first consider how this test particle interacts with the axisymmetric part B^{m=0} of Earth's field, the leading term of which is the dipole field explicitly displayed in Eq. (1). In K, −∂B^{m=0}/∂t=0=∇×E. The condition ∇×E=0 allows E=−∇V, with V an electric potential, but absent any electrostatic charge buildup (this is returned to below), ∇V=0 and one may put E=0 in the Lorentz force law so that q experiences a force

$${F}^{m = 0} = qv \times {B}^{m = 0} . \qquad ( 4 )$$

This is the Earth system's manifestation of the Lorentz force observed in the rotating cylindrical capacitor experiments. The force F^{m=0} must be the same force to [symbol] (ν/c)² in K′. In frame K′ (our laboratory frame), q has v=0 relative to the frame, so there is no v×B force. However, there is an electric field in K′ due to the relativistic field transformation to O(ν/c)²:

$${E}^{′} = E + v \times B \qquad ( 5 )$$

And the Lorentz force law in K′ becomes, since E=0,

$${F}^{′ m = 0} = {qE}^{′} = q ( E + v \times {B}^{m = 0} ) = qv \times {B}^{m = 0} . \qquad ( 6 )$$

That is, in K′, there is no v×B force since v=0 but there is now an electric field E′ that exerts a force on q identical to that due to vλB in K. Note that the field transformation to O(ν/c)² for the magnetic flux density is just B′=B.

Does the charge q also experience a net force from its motion in frame K in the presence of the B^{m≠0} field? The leading components of the m+0 field are given by Eq. (2). In a modern understanding of v in the Lorentz force law, the fact that these components are also, like q, rotating at frequency ω in K does not change the existence of a qv×B^{m≠0} force on q. But for the m≠0 components there is an additional force present that is absent for the m=0 components, because ∂B^{m≠0}/∂t≠0 in K. In frame K Maxwell's Faraday equation requires

$$\partial {B}^{m \neq 0} / \partial t = - ∇ \times E \qquad ( 7 )$$

By direct calculation from Eq. (2) using φ′=φ−ωt, it is easy to verify

$$\partial {B}^{m \neq 0} / \partial t = ∇ \times ( v \times {B}^{m \neq 0} ) = - ω \partial {B}^{m \neq 0} / \partial {φ}^{′} \neq 0 , \qquad ( 8 )$$

Equating Eqs. (7) and (8), the simplest choice for E is

$$E = - v \times {B}^{m \neq 0} \qquad ( 9 )$$

So in frame K for the m≠0 components there is a v×B field but also an E field of equal and opposite sign. The Lorentz force in K due to the m+0 components is then

$${F}^{m \neq 0} = q ( E + v \times {B}^{m \neq 0} ) = 0 \qquad ( 10 )$$

Which means F^{m≠0}=0 in K′ as well.

Why would a charge q feel no force from the m≠0 components in the laboratory frame K′? As with the m=0 components, q has v=0 in the laboratory, so there is no v×B force. But by Eqs. (5) and (9), the electric field E′=0 in K′, unlike the case for the m=0 components. Then Ohm's law in K′ gives

$${F}^{m \neq 0} = {qE}^{′} = 0 \qquad ( 11 )$$

Formally, Eqs. (7) and (8) admit a solution E=−v×B^{m≠0}−∇V, which would give E′=−∇V. (It is noted that ∇=∇′.) But this V cannot establish a Lorentz force for the m≠0 components analogous to Eq. (4). By Eq. (11), to achieve F′=qv×B^{m≠0} from E′=−∇V, one would have to have ∇V=−v×B^{m≠0}. But this choice is impossible because ∇×∇V=0 whereas ∇×(v×B^{m≠0})≠0 by Eq. (8). The rotating nonaxisymmetric field does not, and cannot, produce a Lorentz force analogous to that produced by the axisymmetric field.

### Conditions Required for Voltage Generation

Because the m≠0 components of Earth's field produce no net force on charges rotating with Earth, they cannot be used to drive an electric current. However, the axisymmetric m=0 components of Earth's total field (henceforth simply designated B for notational simplicity) do lead to a qv×B force, so the results of this force are examined further here. In any conductor carried by Earth's rotation, the effect of this force is to rapidly redistribute electrons, until the resulting electrostatic field E=−∇V perfectly cancels the driving force:

$$v \times B = ∇ V . \qquad ( 12 )$$

(Note ∇×(v×B^{m≠0})=0 so Eq. (12) may be satisfied, unlike the case for B^{m≠0}) The classical charge relaxation timescale for this electron redistribution to occur is ∈₀/σ˜10⁻¹¹ (1 S m⁻¹/σ) s, where ∈₀ is vacuum permittivity, σ electrical conductivity, and for reference Earth's seawater has σ=3.3 S m⁻¹. Equation (12) has been used to estimate depth- and latitude-dependent volume charge densities due to electron redistribution within the Earth itself as high as ˜1e⁻ m⁻³.

The extremely rapid and continuously ongoing field cancellation within any conductor appears to make it impossible to use the v×B force to generate electricity even for the m=0 components of Earth's field. However, Eq. (12) hides an implicit assumption that can be violated. Since ∇×∇V=0 always, Eq. (12) cannot be satisfied within a magnetically permeable object with a topology chosen to ensure

$$∇ \times ( v \times B ) \neq 0 \qquad ( 13 )$$

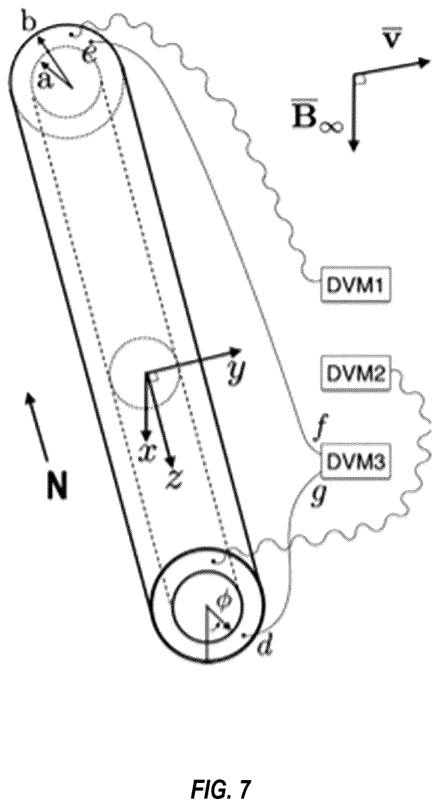

within the object. The inequality of Eq. (13) holds, for example, in the interior region a<ρ<b of a magnetically permeable conducting cylindrical shell of inner and outer radii a and b (with ρ the radial coordinate in a cylindrical coordinate system centered in the shell), and long axis perpendicular to v and B (see FIG. 7). In such an object, by Eqs. (12) and (13) electrons cannot arrange themselves to cancel the qv×B force experienced as the shell is carried by Earth's rotation through Earth's Bₘ₌₀ field. Therefore, there are unbalanced forces, so there is a possibility of driving a continuous current.

The electromotive force (emf) around a path (within the conducting shell is given by Eq. (3). But because of the −∂B/∂t term in Eq. (3), Eq. (13) does not guarantee a nonzero emf. Determining whether currents actually flow requires an examination of the integrand of Eq. (3) and the conditions under which it will be nonzero.

Any moving conductor that obeys Ohm's law satisfies

$$E + v \times B = J / σ = η ∇ \times B \qquad ( 14 )$$

Where J is the current density and magnetic diffusivity η=(σμ⁻¹). Taking the curl of Eq. (14) gives the advection-diffusion equation for B within that conductor,

$$- \partial B / \partial t + ∇ \times ( v \times B ) = η {∇}^{2} B \qquad ( 15 )$$

for constant η. The left-hand side of Eq. (15) integrated over the relevant surfaces S is evidently the emf around the corresponding path Cin Eq. (3). The right-hand side of Eq. (15), and so the emf in Eq. (3) must be negligible if (lies within a conductor with magnetic Reynolds number Rₘ=σμvξ>>1, where & is the length scale over which B changes appreciably within the conductor.

In summary, a nonzero emf is possible provided a magnetically permeable conductor that satisfies two requirements is chosen: a topology (such as a cylindrical shell) that satisfies Eq. (13); and a conductivity, permeability, and scale that yields

$${R}_{m} = σμ v ξ < 1. \qquad ( 16 )$$

Because by Eqs. (3) and (15) it is only certain that emf is 0 if Rₘ>>1, it may also be possible to generate a non-zero emf for 1≤Rₘ<10.

It is well-known that a magnetically permeable cylindrical shell oriented as in FIG. 7 perpendicular to the field B_{∞} will distort that field near and within the shell. The resulting field for a shell that has velocity v=0 when there is no electric field present must satisfy, by Eq. (14),

$$∇ \times B = 0 \qquad ( 17 )$$

This in turn means that B can be written as the gradient of a magnetic potential W, B=−∇W, so ∇·B=0 yields a Laplace equation for W that may be solved with boundary conditions on B and H for the shell to give the resulting field within and exterior to the shell. This field will be called B₀ to indicate that it is the v=0 solution. In this static situation, current flow within the shell will clearly not take place. But if a conducing magnetically permeable cylindrical shell has v≠0, Eq. (14) instead yields not Eq. (17) but ∇×B=η⁻¹ (E+v×B), which cannot in general be satisfied by choice B=−∇W, and the familiar solution B₀ is not correct. Eq. (15) must instead be solved in full. Shifting the frame to K′, in which Eq. (14) becomes E′=η∇×B′, does not change this conclusion as it merely introduces an electric field E′=v×B.

If the permeable cylindrical shell has Rₘ>>1, then the distorted magnetic flux density within the shell interacts with charged particles q within the conductor analogously to the way the m≠0 components of Earth's magnetic field do and E=−v×B, or very nearly so. Then B₀ once again becomes the correct solution, at least to high precision. The focus will therefore be on shells satisfying Rₘ<1.

Equation (15) may be solved analytically when the shell is oriented as in FIG. 7 along geographic south-to-north, orthogonal to both B_{∞}=B_{∞}\hat{x}, the m=0 part of Earth's magnetic flux density far from the shell, and to v=vŷ, Earth's rotation velocity at the shell's location. The x component of that solution is

$${B}_{sx} ( a < ρ < b ) = {β}_{1} - {{β}_{2} ( a / ρ )}^{2} {e}^{ky} \{ [ k ρ cos 2 ϕ + {( k ρ )}^{2} sin ϕ ] {K}_{1} ( k ρ ) - {( k ρ )}^{2} {sin}^{2} ϕ {K}_{0} ( k ρ ) \} \qquad ( 18 )$$

Where y=ρ sin φ, K₀(kρ) and K₁(kρ) are modified Bessel functions of the second kind of order 0 and 1, 2 kb=μσvb=Rₘ, β₁=2B_{∞}μᵣ(μᵣ+1)[(μᵣ+1)²−(a/b)²(μᵣ−1)²]⁻¹, and

$${β}_{2} = 2 {B}_{∞} {{μ}_{r} ( {μ}_{r} - 1 ) [ {( {μ}_{r} + 1 )}^{2} - {( a / b )}^{2} {( {μ}_{r} - 1 )}^{2} ]}^{- 1} . \qquad ( 19 )$$

Relative permeability μᵣ is defined by μ=μᵣμ₀, with vacuum permeability μ₀=1.257×10⁻⁶ N A⁻².

The condition Rₘ<1 corresponds to kρ<½ in Eq. (18), which may then be expanded by taking series expansions in kρ (corresponding to powers of Rₘ) for e^{kρ}, K₀(kρ), and K¹(kρ). It's found that

$${B}_{s} = {B}_{0} + {\sum }_{n = 1}^{N} {B}_{n} + {𝒪 ( {R}_{m} )}^{N + 1} , \qquad ( 20 )$$

where B₀ is the usual magnetic flux density in a<ρ<b for a magnetically permeable shell when v=0, and Bₙ (n=1, 2, 3 . . . . N) is an nth-order in Rₘ perturbation to B₀ that enters when v≠0.

### Voltage Generation

The emf along a path C between the points d and e within the cylindrical shell is, by Eqs. (3) and (14),

$$ε = η {\int }_{\overline{C}} ( ∇ \times {B}_{s} ) \cdot dl , \qquad ( 21 )$$

Where Bₛ is the magnetic flux density within the shell, i.e., for ρ such that a<ρ<b. It was previously shown that there exist closed paths within the cylindrical shell around which emf≠0 to [symbol] (Rₘ). It is also noted, however, that it is unclear as a practical matter that attaching electrodes to the exterior of the shell would enable one to select or access any particular path, since the shell is a continuous homogenous conductor and one expects current to flow over many possible interior paths. Therefore, in experimental practice, a digital multimeter voltage or current leads are attached to the ends of the shell, as depicted in FIG. 7, giving a path from d to e through the shell, to f at the positive terminal of Digital Voltmeter (DVM)3, through DVM3 to g, DVM3's negative terminal, then back to d.

This approach has the merit of simplicity: DVM3 connects to the ends of the cylindrical shell with clip leads, with the top of each clip at ρ=b and the bottom at ρ=a. Given the configuration shown in FIG. 7, one can choose whether to measure the voltage or current simply by turning the dial on the multimeter between μV and uA settings and appropriately changing the input jacks. This configuration in effect treats the cylindrical shell as a lumped circuit element. Equation (21) then manifests a key prediction: If the entire system in FIG. 7 is rotated by 180 degrees about the x-axis, then the measured emf (subsequent to the decay of any eddy currents caused by the rotation) should change sign, but be of equal magnitude.

The circuit segment in FIG. 7 running from e to d through DVM3 makes no contribution: any nonzero v×B in these segments causes an electron displacement that cancels v×B. EMF generation in the shell from d to e is calculated by evaluating Eq. (21), extending that calculation to higher orders in Rₘ, and averaging over φ from 0 to 2π and ρ from a to b. Details of the calculation described below are given herein.

For the configuration in FIG. 7,

$$η ∇ \times {B}_{s} = - ∇ V - η {∇}^{2} {A}_{s} = - ∇ V - {vB}_{sx} \hat{z} \qquad ( 22 )$$

Where Vis the electric potential, Aₛ=A_{z}\hat{z} is the magnetic vector potential within the shell, and Bₛₓ is just the x component of Bₛ. Equation (22) and the derivation below treat the shell as infinitely long. For an actual finite-length shell, there are end effects that fall off exponentially with distance x into the interior like exp (−3.83z/a) for interior radius a. Therefore, in the experiments a cylinder satisfying L>>2a is used.

Eq. (22) is substituted into Eq. (21) using the expansion Eq. (20), and averaged over φ and ρ. It's found that ∇V+νB₀ₓ\hat{z}, B₁ₓ\hat{z}, and B₃ₓ\hat{z} in Eq. (22) averaged over φ from 0 to 2π each give zero. However, the second-order term is

$${B}_{2 x} ( a < ρ < b ) = - ( {β}_{2} / 8 ) {{R}_{m}^{2} ( a / b )}^{2} [ ln ( k ρ / 2 ) + 4 {sin}^{2} ϕ - 2 {sin}^{4} ϕ + γ - \frac{1}{2} ] \qquad ( 23 )$$

Which does not average to zero over φ and ρ:

$${〈 {B}_{2 x} 〉}_{ρ , ϕ} = \frac{1}{π ( {b}^{2} - {a}^{2} )} {\int }_{0}^{2 π} {\int }_{a}^{b} {B}_{2 x} ρ d ρ d ϕ = \frac{{β}_{2}}{8} {{R}_{m}^{2} ( \frac{a}{b} )}^{2} [ ln ( \frac{4}{{R}_{m}} ) + \frac{{a}^{2}}{{b}^{2} - {a}^{2}} ln ( \frac{a}{b} ) - γ - \frac{1}{4} ] \qquad ( 24 )$$

Then from Eqs. (21) and (22) it's found that

$${〈 ε 〉}_{ρ , ϕ} = v ( {β}_{2} / 8 ) \text{} {{lR}_{m}^{2} ( a / b )}^{2} [ \text{} ln ( {R}_{m} / 4 ) - {{( a / b )}^{2} [ 1 - {( a / b )}^{2} ]}^{- 1} \times ln ( a / b ) + γ + 1 / 4 ] + {𝒪 ( {R}_{m} )}^{4} , \qquad ( 25 )$$

where γ=0.5772 is Euler's constant and/is the distance between points d and e. By Eqs. (25) and (19), [symbol] ε [symbol] _{ρ,φ}=0 if a=0 (as must be so since ∇×(v×B)≠0 for a solid cylinder), or if μᵣ=1. At Princeton's location B_{∞}=45 μT (obtained by summing the dipole, quadrupole, and octupole components of Earth's m=0 field) pointed downward into Earth's surface at an angle (from the horizontal when facing the north geographic pole) of 57.5 degrees, and the direction to the geographic pole is currently 12.6 degrees east of magnetic north. For μᵣ>>1, β₂˜2B_{∞}/[1−(a/b)²]=143 μT.

### Materials and Methods

To test the prediction that electricity can be produced by a system that satisfies both Eqs. (13) and (16) a cylindrical shell made of MnZn ferrite, a soft magnetic material with conductivity about that of seawater, is used. The cylindrical shell and an otherwise identical solid cylinder used as a control were produced by National Magnetics Group Inc. The shell of M100 MnZn ferrite has length L=29.9 cm and inner and outer radii satisfying a b=0.61 with b=1.0 cm. The temperature-dependent relative permeability for M100 MnZn ferrite is determined from its data sheet values as described herein. One has μᵣ=9,500±2,850 for the temperatures at which the experiments were conducted. Ambient environmental conditions in the laboratory during the experiments are described herein. The shell's conductivity is determined using voltage and current measurements as described herein; one finds σ=2.07±0.22 Sm⁻¹. The shell's characteristic diffusion length scale is taken to be ξ=b, so

$${R}_{m} = {σμ}_{r} {μ}_{0} vb \qquad ( 26 )$$

At Princeton's latitude the shell has Rₘ˜0.088±0.028, satisfying Eq. (16)

The cylinder and cylindrical shell were mounted on a plexiglass turntable on a wood base (that is, no conducting magnetizable materials were used). The rotation axis of the turntable coincided with the origin of an underlying polar coordinate system. The turntable and underlying base were oriented and tilted to be perpendicular to B_{∞}, as depicted in FIG. 7. Voltages and temperatures were recorded using three battery-operated Gossen Metrawatt Metrahit 30M digital multimeters (labeled in FIG. 7 and elsewhere as DVM3 for the voltage (or current) measuring device and DVM1 and DVM2 for the temperature measuring devices). The Metrahit 30M provides voltage and temperature measurement precisions of 0.1 μV and 0.01 degrees Celsius.

Each experimental run for a particular orientation of the cylinder or cylindrical shell was begun by rotating the shell to its appropriate position and then allowing the system to sit overnight. Voltmeter leads were fixed to the plexiglass turntable, and were rotated together with the shell or cylinder. The multimeters also moved with the rotation. Therefore, there was no circuit topology change under rotation.

Measurements were typically begun in the morning following a period of at least 8 hours subsequent to the shell's rotation into position. Data were recorded on all three multimeters every 10 seconds for 5-10 hour periods. The leads were then disconnected from the multimeters and data downloaded for analysis. Each step in the process is described in greater detail herein.

### Predictions for a Simple Laboratory System

Equation (25) predicts the direct-current emf that DVM3 in FIG. 7 should measure, apart from a thermoelectric contribution (discussed below). For M100 material with b=1.0 cm, a/b=0.61, and l=27.9 cm (l<L because the DVM3 electrodes each extend 1.0 cm in from the ends of the shell), and propagating the uncertainty due to μᵣ and σ, it's predicted that [symbol] ε [symbol] _{ρ,φ}˜−13.7±7.2 μV for the configuration in FIG. 7, the orientation defined to lie at 0 degrees. A rotation by 180 degrees about the x axis should yield the same emf but of opposite sign.

By symmetry, it's expected that the shell in FIG. 7, when rotated to 90 degrees or 270 degrees, will give emf=0 μV. This can also be predicted analytically. For a shell aligned at 270 degrees, for example, v=v\hat{z} and B=(Bₓ, B_{y}, 0) in the shell, with B_{z}=0 as long as end effects are ignored. Explicit calculation then shows ∇×(v×B)≠0 and provided no component of B varies with z (again correct apart from end effects). But when ∇×(v×B)≠0, electron redistribution cancels the qv×B force, giving emf=0.

Therefore, three testable predictions for the M100 cylindrical shell depicted in FIG. 7 have been identified: (1) when the cylindrical shell is oriented at 0 degrees, the system should generate a particular DC emf that lies in the range −13.7±7.2 μV; (2) this emf should reverse sign upon rotation about the x axis to 180 degrees; and (3) emf should be 0 when the system is rotated to 90 degrees or 270 degrees. Two further tests are also proposed: (4) for an otherwise identical solid (a=0) M100 cylinder, Eq. (25) predicts emf=0 for all orientations; and (5) by Eqs. (3) and (14), a cylindrical shell with Rₘ>>1 should produce zero voltage at all orientations.

### Experimental Results

### Controlling for the Seebeck Voltage

Testing these predictions requires controlling for potentially confounding Seebeck voltages. A temperature gradient ΔT along the cylindrical shell between the two DVM3 electrodes will lead to a Seebeck voltage

$${ε}_{s} = - S Δ T \qquad ( 27 )$$

Where S is the Seebeck coefficient. For many ordinary conducting metals, S˜1-10 μV K₋₁; for semiconductors the sign of S can be positive or negative depending on the dopant. MnZn ferrites have the general formula MnₓZn₁₋ₓFe₂O₄, with electrical properties varying greatly with x. Unfortunately, MnZn ferrites have especially large Seebeck coefficients, with published S values for five different MnZn ferrites in the range ±(500-800) μV K⁻¹. The experiments described below determined S for M100 material to be −417 μV K⁻¹. The Cu DVM3 leads have such a low comparative Seebeck coefficient, S=1.9 μV K⁻¹ at room temperature, that this small additional effect can be ignored.

Ambient vertical and horizontal temperature gradients in the laboratory can reach ˜1 degree C. m⁻¹, leading to values for ΔT along the cylindrical shell as large as 0.3 degrees C. By Eq. (27), this could result in Seebeck voltages as high as εₛ˜±120 μV, obscuring the −14±7 μV signal expected from the effect. Moreover, a persistent ambient ΔT could mimic the predicted sign reversal in the emf generated by the effect when the system is rotated.

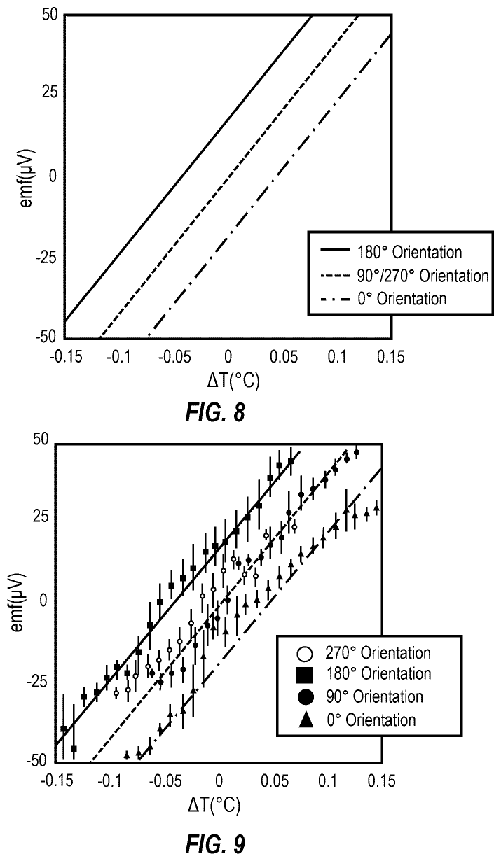

It is therefore essential that εₛ is controlled for as a function of ΔT. As shown in FIG. 7, simultaneously with recording emf (or current) values by DVM3, temperatures T₁ and T₂ measured by DVM1 and DVM2 are respectively recorded using thermocouples in thermal contact with opposite ends of the shell. DVM3 records an emf= [symbol] ∈ [symbol] _{ρ,φ}+εₛ, and as illustrated in FIG. 8, this can be plotted against ΔT=T₁−T₂. When [symbol] ∈ [symbol] _{ρ,φ}=0, as should be the case for both the a=0 cylinder at any orientation, and for the a/b=0.61 shell in a 90 degree or 270 degree orientation, the data should fall along a line (the dashed line in FIG. 8) that passes through the origin: emf=0 when ΔT=0. If the effect predicted in this paper did not exist, then the a/b=0.61 shell should also generate voltages lying on this dashed line at any orientation. But if the effect exists, then distinct parallel lines offset from the dashed line should result for 180 degrees (solid line) and 0 degrees (dot-dash line) due to emf generation at these orientations.

Later, additional laboratory measurements are described to exclude the possibility that the DC voltages and currents generated could somehow be due to 60 Hz or RF background.

### Testing Five Predictions

Experimental results for the a/b=0.61 cylindrical shell are shown in FIG. 9 and compared with the predictions of FIG. 8. As predicted in FIG. 8, orientations of 90 degrees (black circle) and 270 degrees (white circle) show the effects of Seebeck voltages εₛ only [Eq. (27)], whereas orientations of 0 degrees (triangles) and 180 degrees (squares) show predicted additional voltages [symbol] ε [symbol] _{ρ,φ} [Eq. (25)] of appropriate, and equal and opposite, magnitude. As also predicted by Eq. (25), the sign of the voltage displacement measured for the 0 degree orientation is negative, whereas the voltage displacement measured by the cylindrical shell when rotated to 180 degrees is positive.

As discussed in greater detail herein, voltmeter leads were secured to the plexiglass turntable upon which the cylindrical shell was mounted, so that the topology of the multimeter-leads-shell circuit did not change under rotation. This was done to rule out any possible circuit-topology effects that, at least in certain ∂B/∂t≠0 circuits, can alter voltage magnitude and sign.

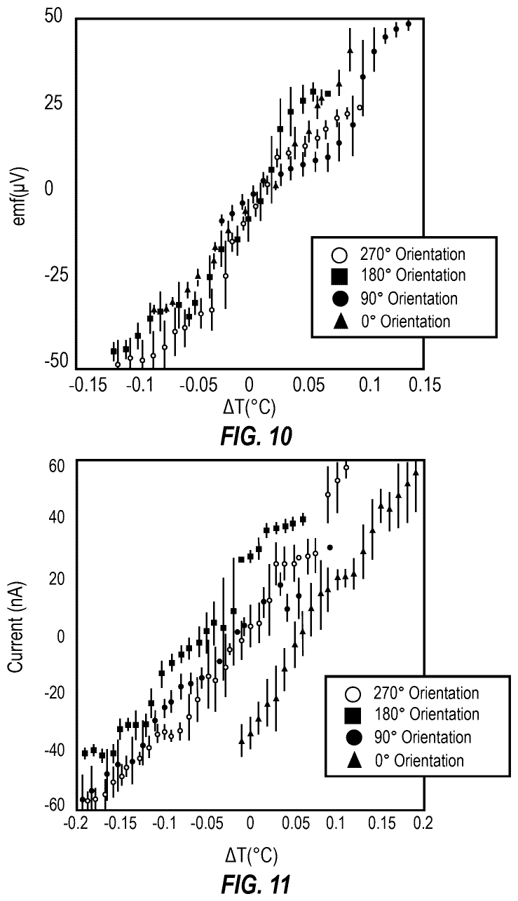

Results for the a=0 control are shown in FIG. 10. By Eq. (25) this solid cylinder, otherwise identical to the shell used for FIG. 9, is predicted to generate [symbol] ε [symbol] _{ρ,φ}=0 for all four orientations, so that the three separated lines of data predicted in FIG. 8 should collapse into a single line, as is found. It is clear from FIGS. 9 and 10 that results for the system strongly corroborate the predicted results.

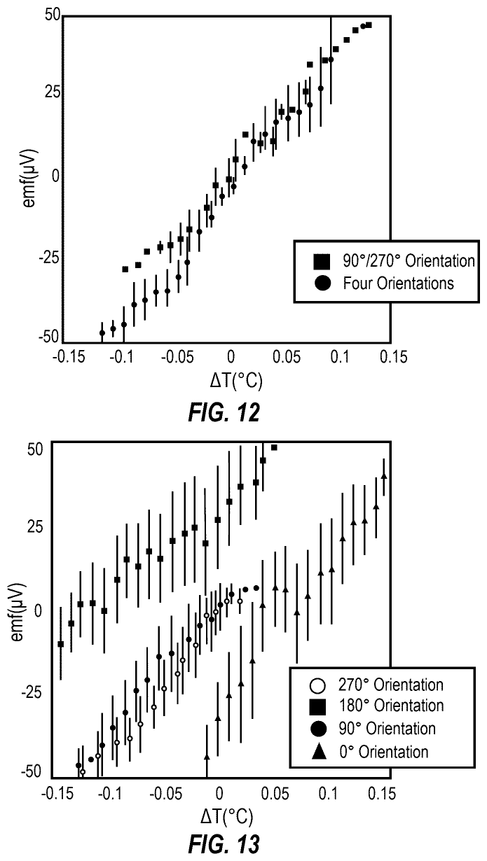

In FIG. 12, the combined data of FIG. 10 (solid circle) for the a=0 cylinder is plotted together with the combined 90 degree and 270 degree data of FIG. 11 (square) for the a/b=0.61 cylindrical shell, showing that these coincide. The Seebeck coefficient is given by regression over the former points, since the voltage for the a=0 cylinder should be purely due to the Seebeck effect. Regression over these points in FIG. 12 gives S=−417 μVK⁻¹. A regression over the data in FIG. 9 for the 180 degree orientation for the a/b=0.61 shell gives emf=18.2 μV+419 (μV/° C.)ΔT (R=0.992), showing both the magnitude of [symbol] ε [symbol] _{ρ,φ} and a Seebeck coefficient nearly identical to that found for the a=0 cylinder. Regression over the data for emf at the orientations of 0 degrees and 180 degrees yields | [symbol] ε [symbol] _{ρ,φ}|=17.2±1.5 μV.

The final prediction was that no effect should be observed for a magnetically permeable cylindrical shell having Rₘ>>1. This was tested using a MuMetal shell with Rₘ˜10⁶, and measured emf=0019±0.099 μV at 0 degrees orientation (averaging data over a 9.5 hour run), confirming the prediction.

### Current Measurements

Eq. (25) predicts an emf that should be generated by the system and measurable by the multimeter DVM3 in voltmeter mode across points d and e in FIG. 7. It is also clear from FIG. 7 that DVM3 could instead be used in ammeter mode to measure current flow around the circuit defgd. A few experiments were therefore conducted which measured current (in nA) as a function of ΔT. The results for these experiments are shown in FIG. 11, demonstrating that the system is generating a continuous DC current in addition to a continuous DC voltage- and therefore is generating DC power. Regression over the data for current at the orientation 0 degrees and 180 degrees yields | [symbol] i [symbol] _{ρ,φ}|=25.4±1.5 nA.

### Results Reproduced at Second Location

The experiments providing the data underlying FIGS. 9 and 10 were performed in an environmentally well-controlled underground windowless dark laboratory with low 60 Hz and RF backgrounds, as detailed herein. As a final check to test whether an unaccounted—for local effect could somehow be spoofing the entire array of predicted results obtained in that laboratory, the experiments were reproduced in a residential building 5.5 km east of the original experimental setting. This was a largely unregulated environment, in contrast to that of the primary laboratory. Nevertheless, the data once again show the voltage magnitude and behavior under rotation predicted by the effect (FIG. 13) demonstrating that the observed effect is not due to an unidentified local influence in the primary laboratory.

### Previous Experiments and Objections

The theoretical predictions summarized by Eq. (25) appear to be strongly corroborated by the experimental results presented here. But others have presented results that they argued gave null results and refute those predictions. However, none of their three experiments satisfied the criteria for voltage generation.

One experiment which most closely resembled the experiment proposed here, used a MnZn ferrite cylindrical shell with b=0.94 cm, a=0.51 cm, and L=2.86 cm, and rotated this shell 180 degrees not about the x axis, as in the experiments proposed and executed herein, but about the cylinder's axis of symmetry, the z axis (see FIG. 7 for these axis definitions). They measured an emf of amplitude 1.5 μV that tracked their rotations, consistent with the magnitude of the voltage for their system that they predicted were the effect real. But they argued, in light of the large Seebeck coefficients for MnZn ferrites, that their observations were likely due to a Seebeck voltage driven by a small ΔT experienced by the shell. They did not report temperature measurements during their experiments, but their ambient laboratory temperature measurements were broadly consistent with a Seebeck voltage of the observed magnitude. It is unclear, however, how to disentangle the two effects potentially contributing to their voltage measurement in absence of a control for the Seebeck effect.

But the predictions may well not hold for their system, even were it rotated about the x axis, and even were there a control for the Seebeck effect. A length L>>2a is required for the cylindrical shell in deriving the predictions. For the experimental system whose results are reported here, L=29.9 cm and a=0.6 cm giving L=50a, satisfying this requirement, whereas the system used by others has L=2.8a. Edge effects distort B within the shell away from the B₀ that underlies the calculations, so one cannot expect that the predictions will hold within their system.

They also performed two other experiments that they presented as contradicting the predictions. The first of these involved creating a copper wire circuit in conductive contact with a cylindrical MnZn shell; the second was similar except with the Cu circuit insulated from the shell. However, these experiments are expected to give a null result, because they have Rₘ>>1. It was speculated, at the end of a previous paper, that one might coat an underlying magnetically permeable shell with an “overlying shell” of a thin Cu layer to realize the effect. But it was then stated that to achieve Rₘ<1, given the high conductivity of Cu (˜6×10⁷S m⁻¹), that apparatus would have to be microscopic in size, with b<5 μm. The copper wire circuit work mentioned above used a wire of diameter 0.4 mm in their experiments, giving Rₘ˜10 for their Cu circuit, so that one would expect the measured emf in these experiments to be zero, as they found.

Jeener claimed to show that the integrand in Eq. (3) must always equal 0 for the system, so that no emf could be generated. It was argued that Jeener's conclusion was incorrect because his argument failed to recognize the distinction (reviewed above) between the physical effects of the B^{m=0} and B^{m≠0} terms upon a conductor corotating with Earth. In effect, Jeener treats all magnetic field components as behaving like the B^{m≠0} components, with ∂B/∂t always perfectly canceling ∇×v×B.

It is natural to query energy and angular momentum conservation for the system. It is shown below by a Poynting vector (S=μ⁻¹E×B) calculation that there is net power flowing into the cylindrical shell provided v+0 (or in a frame where v=0 but in which there is an equivalent electric field E=v×B). By explicit calculation, it was showed that this power inflow equals the power lost from Earth's kinetic energy of rotation due to the J×B magnetic braking resulting from this device. (This is reminiscent of what takes place in a homopolar generator). Therefore, energy is conserved: the energy driving currents within the shell ultimately derives from Earth's rotational kinetic energy, mediated by Earth's magnetic field. (Based upon the measured values of the emf and current, the configuration described here—merely an initial experimental demonstration system-taps into only a fraction of the available power. Raising this efficiency is a subject for subsequent investigation, and is also further discussed below.) By contrast, for a solid cylinder with a=0 there is no net Poynting energy inflow, and also no magnetic braking so no despinning of Earth.

A related issue is whether the slight despinning of Earth caused by the cylindrical shell is also consistent with angular momentum conservation. In electrodynamics energy and angular momentum reside in both the electromagnetic field and mechanical rotation, with the field angular momentum density equal to ∈₀ μr×S (where r is the usual radial component in a spherical coordinate system). Mechanical systems can then increase or decrease their angular momentum by exchange with the electromagnetic field. Intuition may be provided by a thought experiment involving an initially nonrotating magnetized charged conducting spherical shell. Angular momentum resides in the static S field of this nonrotating sphere (E is produced by the charge, B by the magnetization, and ∈₀ μr×S≠0). The charge of the sphere is then drained to ground via the sphere's south pole. The sphere goes into rotation due to the J×B force during this draining, and it can be explicitly shown that the angular momentum that had previously resided in the field (now zero because now E=0, since the sphere's charge has been drained) is identical to the mechanical angular momentum acquired by the newly rotating sphere.

It was previously shown that even in an extreme scenario where human civilization would obtain all its electrical energy from the effect describes here, Earth's rotation would slow by <1 ms per decade. By comparison, the length of Earth's day fluctuates by several ms per decade, likely due to interior mass redistributions and core-mantle coupling effects. Earth's solid iron core rotates independently of the bulk Earth, changing from super-rotation to sub-rotation on decadal timescales. Earth is also despinning due to exchange of angular momentum with the Moon, lengthening Earth's day currently by 2.5 ms per century.

### Possible Scaling to Higher Voltages

Results for the simple laboratory demonstration systems appear strongly to confirm the effects predicted by Eq. (25), as do the proposed relevant control experiments. The results have been confirmed at a second location in the same geomagnetic environment. The path appears open to scale this effect to produce useful electrical power. Even if only voltages far below those for residential power were achievable using the effect, such devices might still have practical applications as power sources that would require no fuel and could not wear out in the usual sense.

In principle, the diameter of the system depicted in FIG. 7 could be miniaturized without decreasing the generated emf. Using Eq. (26), the coefficient in Eq. (25) may be written as ν³(B_{∞}/4)l(σμa)²[1−(a/b)²]⁻¹. Decreasing b and a while increasing the values of σ and/or μ (were materials with such characteristics available or created) or v (for example, in an orbiting satellite) would allow many such devices to be physically placed in parallel but connected in series, amplifying the voltages generated. As described in detail below, the power could also be raised by increasing l or by allowing a→b in the shell design. Other configurations satisfying Eqs. (13) and (16) have been considered that could produce electric power.

### Detailed Derivation of the Predicted EMF

Eq. (15) has previously been solved for the magnetic field Bₛ in the interior (a<ρ<b) of the cylindrical shell for the system shown in FIG. 7. The x component of that solution is Eq. (18). Here, it is shown in detail how this equation leads to the predicted emf.

The emf along some path C between the two points d and e within the cylindrical shell is [symbol] ε [symbol] _{ρ,φ} given by averaging over φ and ρ in Eq. (21). For an infinite cylindrical shell, the integrand in this equation for the shell is just equal to

$$η ∇ \times {B}_{s} = - ∇ V - η {∇}^{2} {A}_{s} = - ∇ V - {vB}_{sx} \hat{z} \qquad ( 28 )$$

Therefore, Eq. (21) becomes

$$ε = - {\int }_{\overline{C}} ( ∇ V \times {vB}_{sx} ) dz \qquad ( 29 )$$

The condition Rₘ<1 corresponds to kρ<½ in Bₛₓ(a<ρ<b), which may then be expanded by taking series expansions in kρ (corresponding to powers of Rₘ) for e^{kρ}, K₀(kρ), and K₁(kρ). Thus, there is

$${K}_{0} ( k ρ ) = - γ - ln ( k ρ / 2 ) + {( k ρ / 2 )}^{2} [ ( 1 - γ ) - ln ( k ρ / 2 ) ] + {O ( k ρ )}^{4} \qquad ( 30 )$$

$${K}_{1} ( k ρ ) = {( k ρ )}^{- 1} + ( k ρ / 2 ) [ γ - 1 / 2 + ln ( k ρ / 2 ) ] + ( 1 / 2 ) {( k ρ / 2 )}^{3} [ γ - 5 / 4 + ln ( k ρ / 2 ) ] + {O ( k ρ )}^{5} \qquad ( 31 )$$

$$and$$

$${e}^{ky} = 1 + k ρ sin ϕ + ( 1 / 2 ) {( k ρ )}^{2} {sin}^{2} ϕ + ( 1 / 6 ) {( k ρ )}^{3} {sin}^{3} ϕ + O {( k ρ )}^{4} \qquad ( 32 )$$

One may now write Bₛₓ=B₀ₓ+B₁ₓ+B₂ₓ+B₃ₓ+O(Rₘ)⁴ as a kind of perturbation series about B₀ₓ, with successive terms scaled by successive powers of Rₘ. For the zeroth-order term, one finds

$${B}_{0 x} ( a < ρ < b ) = {β}_{1} - {{β}_{2} ( a / ρ )}^{2} cos 2 ϕ \qquad ( 33 )$$

Which is just the usual field inside a magnetically permeable shell of zero velocity, so that using

$$∇ V = - v {β}_{1} \hat{z} \qquad ( 34 )$$

One has

$$∇ V + v {β}_{0 x} ( a < ρ < b ) = - {{β}_{2} ( a / ρ )}^{2} cos 2 ϕ \qquad ( 35 )$$

Because the integrand in the emf integral is independent of z, one may average the integrand over φ (and φ before performing the integral over z. For the lowest-order term one finds:

$$< ∇ V + {vB}_{0 x} {>}_{ϕ} = \frac{1}{2 π} {\int }_{0}^{2 π} ( ∇ V + {vB}_{0 x} ) d ϕ = 0 \qquad ( 36 )$$

The first-order term, using k=Rₘ/2b, is

$${B}_{1 x} ( a < ρ < b ) = - {R}_{m} {β}_{2} {{a}^{2} ( b ρ )}^{- 1} sin {ϕcos}^{2} ϕ \qquad ( 37 )$$

So that

$$< {B}_{1 x} {>}_{ϕ} = - {R}_{m} {β}_{2} {{a}^{2} ( 2 π b ρ )}^{- 1} {\int }_{0}^{2 π} sin {ϕcos}^{2} ϕ d ϕ = 0 \qquad ( 38 )$$

But the second-order term is

$${B}_{2 x} ( a < ρ < b ) = - ( {β}_{2} / 8 ) {{R}_{m}^{2} ( a / b )}^{2} [ ln ( k ρ / 2 ) + 4 {sin}^{2} ϕ - 2 {sin}^{4} ϕ + γ - 1 / 2 ] \qquad ( 39 )$$

which does not average to zero over φ and ρ:

$$< {B}_{2 x} {>}_{ρ , ϕ} = \frac{1}{π ( {b}^{2} - {a}^{2} )} {\int }_{0}^{2 π} {\int }_{a}^{b} {B}_{2 x} ρ d ρ d ϕ = - \frac{{β}_{2}}{8} {{R}_{m}^{2} ( \frac{a}{b} )}^{2} [ ln ( \frac{{R}_{m}}{4} ) - \frac{{a}^{2}}{{b}^{2} - {a}^{2}} ln ( \frac{a}{b} ) + γ + \frac{1}{4} ] \qquad ( 40 )$$

For the system described herein, one finds <B₂ₓ>_{ρ,φ}=137 nT. The third-order term, using cos 2 φ=1−2 sin₂ φ, is

$${B}_{3 x} ( a < ρ < b ) = - ( {β}_{2} / 8 ) {{R}_{m}^{3} ( a / b )}^{2} ( ρ / b ) \{ [ γ + ( 1 / 2 ) ln ( k ρ / 2 ) ] sin ϕ + ( 7 / 6 ) {sin}^{3} ϕ - ( 1 / 3 ) {sin}^{5} ϕ \} \qquad ( 41 )$$

So that

$${〈 {B}_{3 x} 〉}_{ϕ} = 0 \qquad ( 42 )$$

Eq. (25) then follows. It has been verified that the fourth-order term B₄ₓ does not integrate to zero but makes a negligible contribution to Eq. (21) compared to that of B₂ₓ.

### Materials

The two M100 MnZn ferrite cylinders used in the experiments described in the text were produced by National Magnetics Group Inc. as solid rods through the usual process of sintering. National Magnetics drilled out the long axis of one of these cylinders to produce the cylindrical shell with the requested a/b ratio of 0.6. Final actual values for a and b were determined used a digital micrometer, finding a/b=0.61 with b=1.0 cm. Experiments described herein measured voltages or currents generated by this cylindrical shell as a function of its orientation. Performing simple regressions over the data for emf and current at the orientations of 0 degrees and 180 degrees yields | [symbol] ε [symbol] _{ρ,φ}|=17.3±1.5 μV and [symbol] i [symbol] _{ρ,φ}=25.4±1.5 nA, giving a resistance for the shell of R=683±74 0. One may then calculate σ for the shell from

$$σ = \frac{1}{R} {\int }_{0}^{0.279 m} \frac{dl}{π ( {b}^{2} - {a}^{2} )} \qquad ( 43 )$$

With b=0.01 m and a=0.61b. This gives σ=2.07±0.22 Sm⁻¹ for the shell. This may be compared with the approximate value for M100 material given in the M100 material data sheet as ˜5 S m⁻¹. (The approximation sign here is because the exact value is not measured in a given production run and has substantial uncertainty.)

The relative permeability μᵣ for M100 material is temperature-dependent, as given by a permeability vs. temperature curve presented in the M100 data sheet. The data sheet states that there is a ±30% uncertainty in permeability values for a given M100 sample; that uncertainty is adopted here. The experiments underlying FIGS. 9 to 11 were conducted over a temperature range of roughly 16 to 22 degrees C., but those experiments that led to a determination of the emf due to the predicted effect (those at 0 degree and 180 degree orientations) took place over a more limited temperature range. As measured by the attached thermocouples, cylindrical shell temperatures in these experiments varied from 18.9 degrees C. to 21.5 degrees C. The mean temperature determined for all the temperature readings taken for these experiments was 20.0 degrees C., corresponding to relative permeability of μᵣ=9.5×10³, determined by digitizing the relevant plot from the M100 data sheet. With the ±30% data-sheet uncertainty, μᵣ=9,500±2,850 is used in calculating Rₘ and [symbol] ε [symbol] .

Cylinders or cylindrical shells were attached using non-conductive painter's (masking) tape to a rotatable plexiglass turntable on a wood base (that is, no conducting or magnetizable materials were used). The rotation axis of the plexiglass coincided with the origin of an underlying polar coordinate system (affixed to the wooden base) with angles marked in single degrees. The turntable and underlying base were oriented and tilted to be perpendicular to B_{∞}. At Princeton's location (where the experiments were performed), B_{∞}=45 μT, pointed downward into Earth's surface at an angle (from the horizontal when facing the north geographic pole) of 57.5 degrees, and (in 2022-2024 when the experiments whose results are presented here were performed) the direction to the geographic pole was 12.6 degrees east of magnetic north. The turntable was oriented using a SmartTool digital level (with precision 0.1 degrees, but an uncertainty of ±2° is estimated due to possible systematic errors) and (far from the ferrite) an analog compass redundantly with the NOAA magnetic field calculator mobile digital compass with precision 0.1 degrees, for which an uncertainty of ±5° is estimated due to possible systematic errors.

The MuMetal cylindrical shell used for the Rₘ>>1 control experiment was 15 cm in length, had an outer radius of b=1.65 cm, and an inner/outer radius ratio a/b=0.75, and values of σ˜2×10⁶ S m⁻¹ and μᵣ˜10⁵. This gives Rₘ˜10⁶>>1 for this cylindrical shell.

### Ambient Laboratory Environment

The experiments were performed in a dark windowless basement room with no heating or other climate control present. The only sources of illumination typically present were the LCD displays of the three digital voltmeters and one 60 Hz magnetometer (described herein). Care was taken to ensure that even these faint displays had no line-of-sight path to the M100 cylinder or shell. Any possible photoelectric contribution to the experimentally measured voltage was therefore excluded. Investigators operated by headlamp on those unusual brief occasions when they had to be physically present in the room.

The ambient temperatures were measured within the laboratory in the proximity of the experimental system using two data-logging Extech RH520 meters (with precision 0.1 degrees C.). The displays of these devices would go dark and remain so for the course of their data-logging. The temperature offset between the two meters had been previously determined by placing their two temperature probes directly adjacent to one another and recording temperatures simultaneously for six hours. The two probes were then used to investigate ambient vertical and horizontal temperatures differences in the laboratory in the vicinity of the experimental system. Vertical temperature gradients were always at least 0.6° C. m⁻¹, and could sometimes reach 2° C. m⁻¹. Ambient horizontal temperature gradients were typically below 1° C. m⁻¹. Ambient horizontal temperature gradients appeared to be due to distance from the laboratory door, as well as distance from walls: two laboratory walls were exterior walls, whereas two bordered interior rooms, leading to different temperatures on opposite sides of the laboratory. The vertical temperature gradient is attributed to heat stratification. Preliminary investigations showed that temperatures inside insulating containers quickly acquired a gradient identical to the ambient room gradient, so vertical gradients were close to unavoidable. Ambient horizontal and vertical gradients of these magnitudes meant that there would be Seebeck voltages in the range of ˜±100 μV in the system unless additional steps were taken to suppress these ambient temperature differences. Rather than attempt to eliminate these differences, the differences were controlled for via the approach summarized by FIG. 8, using thermocouple attached to the ends of the M100 shell.

Throughout each run, the 60 Hz magnetic flux density background (B₆₀) was monitored in the proximity of the experimental system using a Magnii Technologies DSP-523 rms 3-axis meter. The meter recorded the maximum value of 60 Hz (plus harmonics) over the course of each run The zero of the DSP-523 had been previously determined from the reading of the instrument while deep inside three nested Magnetic Shield Corporation MuMetal cylinders with lids, with a small axial hole in the lids at one end of all three cylinders, allowing observation of the display of the meter at the far end.

For nearly all runs, the 60 Hz signal experienced during the run was about 6±1 nT, but with occasional spikes as high as 10±1 nT. By taking care to minimize area enclosed by the voltmeter leads, the maximum AC voltage that could be inadvertently induced was limited to V_{AC}=6ωB₆₀ Σ, where Σ is the cross-sectional area of the cylindrical shell. Approximately ⅔ of V_{AC} arises due to concentration of flux density by the permeable material, with about ⅓ of V_{AC} coming from area enclosed by DVM leads outside the footprint of the shell. With ω=2π×60 Hz, B₆₀=10 nT, and Σ=2 cm×30 cm, V_{AC}˜0.1 μV, or two orders of magnitude too small to generate the measured voltages, even if the induced AC voltage were somehow converted to DC voltage with 100% efficiency. In fact, there is anecdotal evidence that strong ambient 60 Hz signals suppress the emf measured in the experiments. It's suspected that this is because 60 Hz acts as a demagnetizing field, and demagnetization of the magnetically soft cylindrical shell should randomize its magnetic domains and lessen or eliminate the predicted effect. It's noted that while B_{∞}=45 μT, the generation of the emf is due to the term [symbol] B₂ₓ [symbol] _{ρ,φ}=137 nT. It's suspected that the presence of 60 Hz background signals that approach this value could substantially decrease the generated voltage due to demagnetization effects at the level of the causative perturbation term.

It was shown in the 1960s that ferromagnetic conductors could rectify microwaves into DC signals. Early experiments found conversion efficiencies (DC voltage generated in ferromagnetic sample vs. incident microwave power) of ˜1 nV/mW. Subsequent research and development has raised these conversion efficiencies to values as high as 1-100 μV/mW. Using an RF Explorer 6G W+ spectrum analyzer, the ambient microwave energies in the laboratory were measured across the range 15 MHz to 6.1 GHz and the highest peak was found to have a power 0.1 nW. Even if the device somehow rectified microwaves with an efficiency 100 μV/mW, this would generate a voltage of only ˜10 nV, a factor ˜10³ times smaller than the measured voltages. Moreover, the effect would have to act for the cylindrical shell but not for the solid cylinder, nor for the Rₘ>>1 cylinder, and coincidentally have to be such that at two locations zero DC signal were generated for the shell at orientations of 90 degrees and 270 degrees.

It's been verified that the predicted effect found in the experiments disappears when the experiments are conducted in an Rₘ>>1 Faraday cage (an LBA Technology Faraday cage made of solid ⅛ inch-thick aluminum was used, giving Rₘ˜50). This is expected since in the laboratory frame K′, v=0 so there is no nonzero qv×B force as such. Rather, the predicted effect as seen in K′ is driven by the corresponding electric field E′=v×B. The Faraday cage cancels this field in its interior, thereby also eliminating the effect. The same issue arises inside a room whose walls, ceiling, and floors are predominantly conducting, as would be the case with surrounding steel construction, for example. While the laboratory had some steel elements present, its walls were made of cinder block and its floor of concrete (albeit with rebar present).

The Faraday cage also provides a second argument that the results are not somehow produced by the 60 Hz background. The skin depth for magnetic flux density in the walls of the Faraday cage is δ=\sqrt{2/μ₀σω}=1.1 cm at ω=2π×60 Hz and taking σ=3.5×10⁷ S m⁻¹ for aluminum. Therefore, for the Faraday cage with wall thickness 0.318 cm, 60 Hz signals are reduced by a factor exp (−0.318/1.1)=0.75 in penetrating the walls. Yet the effect entirely disappears within the cage; it does not merely undergo a slight attenuation.

### Instruments and Experimental Methods

Voltages and temperatures were recorded using three Gossen Metrawatt Metrahit 30M digital voltmeters (labeled in FIG. 7 and elsewhere as DVM3 for the voltage (or current) measuring device and DVM1 and DVM2 for the temperature measuring devices). These were battery operated to eliminate any possible 60 Hz effects due to the meters themselves.

The Metrahit 30M provides voltage measurement precision of 0.1 μV (giving a scale error below for inclusion in calculating measurement errors of ±0.05 μV). The DVM3 voltage leads were twisted and attached to the north and south ends of the cylindrical shell using simple crocodile (alligator) clips. Shell surfaces were first prepared by sanding with a Dremel tool to eliminate any oxidation layer that might be present. A system orientation of 0 degrees was defined to be when the cylinder or shell was oriented as in FIG. 7 and the north end of the cylinder or shell was connected to the positive terminal of DVM3. The positive terminal was connected to a position φ˜145° around the shell (see FIG. 7 for cylindrical and Cartesian coordinate definitions), and the negative terminal to a position φ˜35°. The distance/for this system was l=27.9 cm.

Each experimental run for a particular orientation of a cylinder or cylindrical shell was begun by rotating the shell to its proper position and then allowing the system to sit overnight. The cylinder and cylindrical shell used in the experiments (apart from the MuMetal control) are composed of MnZn ferrite, a soft magnetic material. Following any given orientation change, a shell's magnetic domains reorient in response to B_{∞}. There also is likely to be some settling time for measured voltages due to eddy (Foucault) currents created by rotation of the ferrite.

For both the cylindrical shell and the solid cylinder, voltmeter leads were fixed to the rotatable plexiglass turntable, and were rotated together with the shell or cylinder. The voltmeters also moved with the rotation. That is, care was taken to ensure that there was no circuit-topology change under rotation. This was done because it is known that in certain AC systems with ∂B/∂t±0, potential difference and voltage are distinct quantities, and the measured voltage can vary if the topology of the circuit containing the voltmeter leads varies. Because the circuit topology does not change under rotation, this effect cannot be a factor in the measurements.

Measurements typically began in the morning, following a period of at least 8 hours subsequent to the shell's rotation into position. Data were recorded on the three 30M meters every 10 s for 5- to 10-hour periods. The leads were then disconnected from the Metrahit 30M meter (but always left undisturbed on the ferrite) and data downloaded from each meter to a Panasonic CF-29 Toughbook using Gossen's BD232 interface and software. Care was taken to disturb the ferrite shell or attached leads as little as possible. The 30M meters were powered with Energizer Ultimate lithium batteries, both because lithium batteries have a far more horizontal power vs. time curve than other batteries, and because of the much longer life they allow between battery changes, extending to over 30 hours of data logging with the 30M meter (though in all cases reported here, batteries were replaced after at most 18 hours of use). Replacement batteries were stored near the meters, to keep their temperature close to those of the meters and minimize any thermal excursions upon battery replacement. Some test runs were performed running from about midnight to mid-morning to be sure that the coming of dawn and daylight could not somehow lead to a photoelectric effect that spoofed the predicted results; no effects due to the coming of daylight were found in the data.

The 30M multimeter DVM3 had a small zero-voltage offset. To determine this offset a simple voltage divider was created, producing nominal voltages of about 16 μV. Voltage data was then recorded for a period of 6 hours, then the polarity of the leads was reversed into the DVM3 terminals, and data was recorded for another 6 hours. This procedure was repeated for voltages of 32 μV and 48 μV, intending to cover the likely range of voltages to be measured in the actual experiment. Averaging these results together, a systematic offset upon reversing polarity of 1.20±0.35 μV was found. Voltage data reported herein has taken this offset into account by subtracting 0.60 μV.

Similarly, the zero-current offset for the multimeter DVM3 was determined when operating as an ammeter, on the basis of a 9-hour data logging run across a 330 Ohm resistor. The offset was found to be 0.777±0.053 nA. All current data reported herein has taken this offset into account, by subtracting 0.777 nA from all recorded currents.

Temperatures at opposite ends of the cylinder or cylindrical shell were measured using Pt1000 thermocouple probes attached to two Gossen Metrawatt Metrahit 30M battery-operated meters (designated DVM1 and DVM2 in FIG. 7; DVM1 connects to the thermocouple attached at the same end of the cylinder or shell connected to the positive voltage terminal of DVM3). The Metrahit 30M provides temperature measurement precision of 0.01° C. (giving a scale error below for inclusion in calculating measurement errors of ±0.005° C.).

The probes were positioned at φ=180° at each end of the cylinder or shell (see FIG. 7), with the distal end of the thermocouple container flush with the end of the cylinder or shell. Since this container is metallic, the thermocouple was separated from the M100 material itself by a thin piece of masking tape so that there could be no electrical contact creating an alternate current path. Each thermocouple was secured using masking tape over the top of the shell. Care was taken to treat the two thermocouples identically in positioning and attachment. Different pairs of Pt1000 probes were used for the M100 cylinder and cylindrical shell so that once attached, the probes need never be detached from the cylinder or shell.

Because the difference ΔT=T (DVM1)−T (DVM2) in temperatures measured by DVM1 and DVM2 is important, the relative temperature calibration of DVM1 and DVM2 is crucial. For a given pair of thermocouple probes, prior to their attachment to the cylinder or cylindrical shell, this calibration was determined (after first cleaning the exterior container of each probe) by taping the thermocouple container ends of the Pt1000 probes together and recording temperature data on DVM1 and DVM2 for approximately 6 hours. The data were then downloaded and ΔT=T(DVM1)−T(DVM2) calculated. For the pair of probes used for the solid cylinder, this was ΔT=0.044±0.0054° C. All ΔT data reported herein have taken these offsets into account. Absolute temperature values in the experiments ranged between 16° C. and 21° C.

In order to create plots for experimental data corresponding to the theoretical plot of FIG. 8, the hope with any particular experimental run would be for ΔT to vary due to variations in the ambient temperature gradients in the laboratory across the range of ΔT=−0.15° C. to ΔT=+0.15° C. Some variation in ΔT would typically occur due to diurnal or secular temperature variations, but often the range in ΔT would be sampled as a result would be only a fraction of the entire range from ΔT=−0.15° C. to ΔT=+0.15° C. The data for a given orientation in most figures therefore typically represent data from several different runs that, due to changes in ambient conditions of some tenths of a degree, sampled slightly different ranges of ΔT. Ice contained in sealed plastic bags was sometimes used, typically placed between 0.5 m and 1.0 m from either the DVM1 or DVM2 end of the cylinder or cylindrical shell, as necessary, to gradually manipulate the ambient temperature gradient in the laboratory in order to create conditions approaching the desired range in measured ΔT values.

The same theory that predicts emf generation for conducting ferrite shells when Rₘ≤1 also predicts that emf=0 for a conducting magnetically permeable shell with Rₘ>>1. This prediction was tested and verified with a MuMetal cylindrical shell. Using this shell the south-north orientation and DVM3 electrode positions used in the ferrite shell experiments were duplicated, and data was recorded every 10 s over a 9.5 hour run.

### Data Reduction

In every case, including for calibration runs, the first hour of recorded data was dropped from the data to be analyzed, to exclude any effects on measured values due to warm-up time for the 30M meters after they were turned on and data-taking begun. In addition, each 30M meter would experience occasional data drop-outs, always in the first 1.5 hours of data taking during a run. When these occurred in the data of any one meter at a particular time, the data would be dropped for all three meters for that time from the analysis.

The plots shown in FIGS. 9-13 were produced by grouping all data measured for a particular orientation of the system by ΔT value using a simple MATLAB code. The mean of the corresponding N emf values then gives the data point shown for that ΔT value. The half-height of the error bar for each mean emf value is computed as the Pythagorean sum of the sample standard deviation for that point (i.e. for that ΔT value) and the scale error of ±0.05 μV. Horizontal error bars are omitted, for clarity, but if included, the half-width of the error bar for each ΔT value is simply the relevant scale error of ±0.005° C.

FIG. 12 compares results for emf as a function of temperature gradient for the solid a=0 cylinder (black circles), after combining data for all four orientations shown in FIG. 10, with those for the a/b=0.61 cylindrical shell for orientations 90° and 270° combined (squares). The points are co-linear (albeit with some scatter), as predicted. The slope of a simple linear regression fit to the a=0 cylinder gives a Seebeck coefficient S=−417 μVK⁻¹.

### Second Experimental Site

As an additional check to test whether an unrecognized local effect could somehow be spoofing the array of predicted results verified in the primary laboratory, experiments were reproduced in a largely uncontrolled environment in a residential building 5.5 km east of the primary laboratory's location. These “Site B” experiments were conducted in a dark walk-in closet on the top floor of a private home. The closet was often subject to rapid temperature fluctuations due to uncontrolled air conditioning during the months of July and August 2024. The 60 Hz background in the closet at Site B was higher than in the primary laboratory, with typical values of B₆₀=20 nT and fluctuations reaching 35 nT. Ambient microwave energies were measured in the closet across the range 15 MHz to 6.1 GHz and found the highest peaks to have a power ˜1 nW, about an order of magnitude stronger than had been the case in the primary laboratory. But similar to that case, even if the device somehow rectified microwaves with an efficiency 100 μV/mW, this would generate a voltage of only ˜100 nV, a factor ˜10² times smaller than the measured voltages. Moreover, this effect would again coincidentally have to be such that no DC signal was generated for the shell at orientations of 90 degrees and 270 degrees, and this coincidence would have to hold both in the primary laboratory and at Site B.

Experimental data for Site B are noisy with correspondingly larger error bars in comparison with the results obtained in the primary laboratory. Nevertheless, the data once again show voltage magnitude and behavior consistent with the predictions, as seen in FIG. 13. These results imply that the data obtained in the primary laboratory are not due to an unidentified effect that is somehow spoofing the behavior predicted for the effect.

Ambient room temperatures at Site B typically lay between 23° C. and 25° C. The mean temperature over all of the data taken at orientations of 0 degrees and 180 degrees was 24.0° C. This leads, according to the permeability vs temperature curve included in the M100 datasheet, to a higher relative permeability for the M100 shell than had been the case in the laboratory (where, as noted above, the mean temperature over all data taken at orientations of 0 degrees and 180 degrees had been 20° C.). Moreover, it has been shown that the conductivity of MnZn ferrites also increases with increasing temperature, as long as one remains below the Curie point. Since [symbol] ε [symbol] varies roughly like

$${μ}_{r}^{2} {σ}^{2} ,$$

the experiment is expected to generate somewhat higher emf values at Site B than in the primary laboratory. This is observed, but the size of the one-sigma error bars for emf measurements in this uncontrolled environment makes it too uncertain to attempt too much quantification of these results.

Because at Site B the multimeters were operating in a warmer environment than had been the case in the primary laboratory, the voltage offset for DVM3 was determined anew and the offset in ΔT between DVM1 and DVM2. The emf offset for DVM3 was reevaluated: an emf of 0.27±0.10 μV over a 15-hr run. The voltage data shown in FIG. 13 have taken this slightly changed offset into account by subtracting 0.27 μV from all recorded DVM3 voltages. The ΔT offset for DVM1 and DVM2 was also reevaluated; ΔT was found to be 0.0026±0.0072° C. over a 14.5-hr run. The data shown in FIG. 13 have taken this offset into account by subtracting 0.0026° C. from all ΔT values.

### Scaling Power to Practical Levels

In the laboratory frame K′, v=0 so there is no magnetic v×B force, but there is instead an electric field given by the usual relativistic field transformation for (v/c)²<<1: E′=E+v×B. Ohm's law in K′ is simply E′=J′/σ which leads by Maxwell's equations to the induction equation in K′:

$$\partial B / \partial {t}^{′} = η {∇}^{2} B \qquad ( 44 )$$

Since J′=J and B′=B when (v/c)²<<1, the emf is given by

$${emf}^{′} = {∮}_{C} {E}^{′} \cdot {dl}^{′} = {σ}^{- 1} {∮}_{C} J \cdot dl = η {∮}_{C} ( ∇ \times B ) \cdot dl \qquad ( 45 )$$

Note that to [symbol] (v/c)², emf′=emf and dl′=dl.

A Poynting vector analysis in K′ makes it clear that there is a net flow of energy into our Rₘ≤1 cylindrical shell, providing the power required to sustain emf′≠0. The Poynting vector in K′ is

$${S}^{′} = {μ}^{- 1} ( {E}^{′} \times B ) = {μ}^{- 1} η ( ∇ \times B ) \times B , \qquad ( 46 )$$

where we have used E′=J/σ and Ampere's law. Were it the case that B=B₀, the magnetic flux density expected in a permeable cylindrical shell when v=0, we would have S′=0 by V×B₀=0 in Eq. (46) and there would be no energy input to the cylindrical shell. However, ∇×B_{1≠0} and we find

$$η ∇ \times B = v ( {β}_{1} - {B}_{x} ) \hat{z} , \qquad ( 47 )$$

giving

$${S}^{′} = v {μ}^{- 1} ( {β}_{1} - {B}_{x} ) ( {B}_{x} \hat{y} - {B}_{y} \hat{x} ) , \qquad ( 48 )$$

We perform our calculations at the instant at which the origins of the K′ and K frames coincide. The net energy flux

$${P}_{s}^{′}$$

into the cylindrical shell's surface within l/2≤z≤l/2 (where l/2 is chosen to be sufficiently far in from the shell's edge at L/2) is given by:

$${P}_{S}^{′} = {\int }_{0}^{2 π} {\int }_{- l / 2}^{l / 2} {S}^{′} \cdot \hat{ρ} ρ d ϕ dz , \qquad ( 49 )$$

where \hat{ρ}=cos φ\hat{x}+sin φ\vec{y} and the boundaries at both ρ=b and ρ=a must be taken into account by summing the contributions from evaluating Eq. (49) at ρ=b and ρ=a. The boundary at ρ=a enters with a negative sign, opposite from that at ρ=b. The calculation is simplified by noting

$$( {B}_{x} \hat{y} - {B}_{y} \hat{x} ) \cdot \hat{ρ} = - {B}_{y} cos ϕ + {B}_{x} sin ϕ = [ {β}_{1} + {{β}_{2} ( a / ρ )}^{2} ] sin ϕ + {O ( {R}_{m} )}^{2} , \qquad ( 50 )$$

i.e. the O(Rₘ)¹ terms cancel in Eq. (50). Here as earlier,

$${β}_{2} = 2 {B}_{∞} {μ}_{r} ( {μ}_{r} - 1 ) ζ , \\ and \qquad ( 51 )$$

$$ζ = {[ {( {μ}_{r} + 1 )}^{2} - {( a / b )}^{2} {( {μ}_{r} - 1 )}^{2} ]}^{- 1} , \qquad ( 52 )$$

In Eq. (49), nearly all terms integrate to zero, and we find

$${P}_{S}^{′} = ( π / 4 ) σ {v}^{2} {β}_{2}^{2} {a}^{2} [ 1 - {( a / b )}^{2} ] l + {O ( {R}_{m} )}^{2} , \qquad ( 53 )$$

$${P}_{S}^{′} = 0$$

if v=0, or μᵣ=1 (because then β₂=0), or a=0. Otherwise, the Poynting vector S′ in K′ gives a net energy flow into the cylindrical shell that sustains the emf.

When Rₘ<1, in the steady-state, we have E=−∇V=vβ₁\hat{z}. Together with Ampère's law and Eq. (47), this gives

$$E \cdot J = σ {v}^{2} {β}_{1} ( {β}_{1} - {B}_{x} ) . \qquad ( 54 )$$

By Ohm's law for a moving conductor, we also have

$$E \cdot J = {σ}^{- 1} {J}^{2} + ( J \times B ) \cdot v . \qquad ( 55 )$$

Integrating Eq. (54) over the volume dV=ρdφdρdz gives zero, so Eq. (55) implies

$${σ}^{- 1} {\int }_{V} {J}^{2} dV = - {\int }_{V}^{} ( J \times B ) \cdot v d V , \qquad ( 56 )$$

where the integral on the right-hand side is the familiar expression for magnetic braking. In K, Joule heating therefore derives from the energy made available by magnetic braking of the cylindrical shell. Since the shell is being carried by Earth, it is clear that electrical power in our system derives ultimately from the kinetic energy of Earth's rotation.

Explicitly integrating (J×B)·v in Eq. (56) over the volume V of the shell with J=μ⁻¹∇×B shows the power removed from Earth's rotational kinetic energy to be:

$$\begin{matrix}{P}_{k} = - σ {v}^{2} l {\int }_{a}^{b} {\int }_{0}^{2 π} {B}_{x} ( {β}_{1} - {β}_{2} ) ρ d ρ d ϕ \\ = ( π / 2 ) σ {v}^{2} {β}_{2}^{2} {la}^{2} [ 1 - {( a / b )}^{2} ] + {O ( {R}_{m} )}^{2}\end{matrix} \qquad ( 57 )$$

Were B=B₀, we would have Pₖ=0 since ∇×B₀=0. If ν=0 or μᵣ=1 or a=0, then Pₖ=0.

The manner in which this power arises in K′ is of interest. Poynting's theorem states that the rate at which work is done on the electrical charges within a volume V of surface area E is equal to the decrease in energy stored in the electric and magnetic fields, minus the energy that flowed out through the surface bounding the volume. In K′, Poynting's theorem is:

$${\int }_{V} {E}^{′} \cdot J d V = - {μ}^{- 1} {\int }_{V} B \cdot \partial B / \partial {t}^{′} dV - {\int }_{\sum } {S}^{′} \cdot d \sum \qquad ( 58 )$$

where the displacement current is negligible. By Eq. (44), E′·J=σ⁻¹ J². The second term on the right of Eq. (58) is just Eq. (49). The first term on the right may be evaluated using Eq. (44). The result is identical to Eq. (53).

Therefore in K′, Eq. (58) gives the power

$${P}_{P}^{′}$$

provided to the shell to be

$${P}_{P}^{′} = {σ}^{- 1} {\int }_{V} {J}^{2} dV = ( π / 2 ) σ {v}^{2} {β}_{2}^{2} {a}^{2} [ 1 - {( a / b )}^{2} ] l + {O ( {R}_{m} )}^{2} \qquad ( 59 )$$

The power in K (Eq. 57) equals that in the laboratory frame K′ (Eq. 59) to O(ν/c)².

By Eq. (19) for β₂, for the special case μᵣ>>1, Eq. (59) becomes to O(Rₘ)²,

$${P}_{P}^{′} = 2 π σ {v}^{2} {B}_{∞}^{2} {{a}^{2} [ 1 - {( a / b )}^{2} ]}^{- 1} l \qquad ( 60 )$$

This is the power that flows into our device from Earth's rotation via Earth's rotational kinetic energy through its own axially symmetric magnetic field.

We consider two ways to harvest the power transferred to our device according to Eq. (60). The first is to generate current directly from the device, as we have demonstrated already for low voltages in the laboratory. Then we can use the dependence in Eq. (51) on σ, μᵣ, a, b, and l to scale to higher voltages—provided, of course, that we maintain the constraint that Rₘ be less than or not be much greater than 1. Producing useful power would likely, as a practical matter, require putting many such devices in series and/or parallel. This approach would produce DC electric power. By the maximum power transfer theorem at most half of this electrical power could be transferred to the load.

A second approach is to use the power flowing into our devices according to Eq. (60) not as a source of electricity directly from the device, but rather simply as a source of heat. Absent an
external circuit, currents flow in loops within each device (which is easily demonstrated by calculating the line integral of the emf around various interior paths), dissipating the energy inflow given by Eq. (60) by ohmic losses. We could then assemble a large enough number of these devices to heat water or some other working fluid that would ultimately be used to turn a turbine and produce AC electricity. For example, in the case of water, the water would be heated by the devices within a pressure vessel to steam, and if configured as in a typical fossil fuel plant, the steam would circulate in a direct circuit to turn the turbine.

This approach could be taken using devices of any topology that give ∇×(v×B)≠0. To illustrate one example, here we choose magnetically permeable cylindrical shells (hollow cylinders) with Rₘ˜1. In this example, these hollow cylinders will be efficiently packed in parallel, with long axes perpendicular to both Earth's magnetic field and the direction of Earth's rotation.

The power density (

$${P}_{V}^{′}$$

in W m⁻³) for one such device may then be calculated by dividing Eq. (60) by the volume occupied by the cylinder, giving

$${P}_{V}^{′} = {P}_{P}^{′} / ( π {b}^{2} l ) = 2 σ {v}^{2} {{{B}_{∞}^{2} ( a / b )}^{2} [ 1 - {( a / b )}^{2} ]}^{- 1} \qquad ( 61 )$$

where we take the hollow interior of the device to be “lost” volume from the point of view of heat production (though it can be used as a coolant channel, as discussed below). Eq. (61) is maximized by having a/b approach 1 and choosing σ to be as large as possible consistent with the rough constraint Rₘ=σμᵣμ₀vb≲1.

There are many possible choices of magnetically permeable conducting materials that can satisfy these requirements. As a specific example, we choose a particular permalloy (one of a class of Ni—Fe magnetic alloys), 2-81 permalloy, which has σ=100 S m⁻¹ (an unusually low conductivity for a permalloy) and μᵣ=125. Setting Rₘ=1 then gives b=18 cm as the radius of our cylindrical shell. Permalloys have been deposited in films as thin as 200 nm; here we assume that we are depositing a film of 2-81 permalloy 10 μm in thickness on an underlying cylinder (of any nonconducting, nonmagnetic material) 18 cm in radius. This creates a cylindrical shell of 2-81 permalloy with a/b=(0.18 m)/(0.180001 m)=0.9999944. Using these parameter values in Eq. (61) gives P′_{V}=4.6×10³ W m⁻³.

This result is for a single cylinder; we now assume that we pack many such cylinders together and make an effort to minimize the overall volume. The maximum ordered packing density for cylinders occupies a volume fraction Γ=π\sqrt{3}/6˜0.907, so the power density for an overall structure consisting of many such packed cylinders is just 4.1×10³ W m⁻³. Suppose we now wanted to construct a volume of these objects large enough to produce 500 MW(th). This would require 1.2×10⁵ m³; were this structure shaped like a simple cube it would be a cube 49 m on each side. Clearly the scale and power output of such a power plant could be scaled to either larger or smaller values. A more realistic study for such a power plant could find that Γ must be larger than its minimum value used here.

To produce power, a coolant must flow through these hollow cylinders (if coolant flows within the cylinders themselves) or alongside them (in the (1−Γ) fraction of the volume left unoccupied by the cylinders themselves). If the coolant chosen is water, it is interesting to make a comparison with a modern 500 MW(th) coal power plant. Such a coal plant produces about 400 kg s⁻¹ of steam at 200 bar pressure (with the higher pressure lowering water's heat of vaporization) to turn a turbine and generate electrical power. If we assume that our 10 μm permalloy layer is underlain by 1 cm of solid nonconducting, nonmagnetic material, with the remainder of the interior of the cylinder being hollow (so providing the coolant a channel through which to flow and extract heat), then a fraction (17/18)²/Γ=0.98 of the total volume of the power-producing building (the pressure vessel containing the cylinders and coolant) will in fact be filled with coolant. This corresponds to 1.1×10⁸ kg of (presumably deionized) water, so only a fraction 3.7×10⁻⁶ of this total complement must be converted to steam each second to turn the turbines. This suggests that the coolant could easily be confined to the spaces exterior to the cylinders, though in the end of course this would depend on detailed engineering considerations.

Various modifications may be made to the systems, methods, apparatus, mechanisms, techniques, and portions thereof described herein with respect to the various figures, such modifications being contemplated as being within the scope of the present disclosure. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present disclosure have been shown and described in detail herein, those skilled in the art can readily devise many other varied embodiments that still incorporate these teachings. Thus, while the foregoing is directed to various embodiments of the present disclosure, other and further embodiments of the present disclosure may be devised without departing from the basic scope thereof. As such, the appropriate scope of the present disclosure is to be determined according to the claims.

1-17. (canceled)

18. A system, comprising:
a plurality of power-generating devices, each power-generating device submerged in a coolant, wherein the plurality of power-generating devices are configured to heat the coolant as the plurality of power-generating devices are carried with Earth's rotation, each power-generating device comprising:
a three-dimensional structure composed of a conductive material having (i) a magnetically permeable material having a topology that alters Earth's magnetic field such that curl (v×B)≠0, where v is Earth's velocity of rotation and B derives from the component of Earth's magnetic flux density symmetric about Earth's axis of rotation and (ii) a magnetic Reynolds number less than ten (Rₘ<10); and
wherein the three-dimensional structure is configured to generate power and heat when carried with Earth's rotation through Earth's axially symmetric non-rotating magnetic field; and
at least one turbine disposed external to the coolant and configured to be turned by generated steam.

19. The system of claim 18, wherein steam is produced by the coolant and drives the at least one turbine.

20. The system of claim 18, further comprising a secondary circuit comprising a liquid and configured to absorb heat from the coolant, generate steam when heated, and drive the at least one turbine.

21. The system of claim 18, wherein the coolant comprises at least one of water, carbon dioxide, liquid sodium or other liquid metal, liquid nitrogen and helium.

22. The system of claim 18, wherein the plurality of power-generating devices are oriented along multiple axes configured to continuously generate power.

23. The system of claim 18, wherein a three-dimensional structure of at least one of the plurality of power-generating devices is substantially cylindrical.

24. The system of claim 18, wherein a three-dimensional structure of at least one of the plurality of power-generating devices is substantially ellipsoidal.

25. The system of claim 18, wherein the three-dimensional structure of at least one of the plurality of power-generating devices is substantially a polygonal prism.

26. A system, comprising:
at least one power-generating device thermally coupled to at least one device configured to convert thermal energy to electricity, each power-generating device comprising:
a three-dimensional structure composed of a conductive material having (i) a magnetically permeable material having a topology that alters Earth's magnetic field such that curl (v×B)≠0, where v is Earth's velocity of rotation and B derives from the component of Earth's magnetic flux density symmetric about Earth's axis of rotation and (ii) a magnetic Reynolds number less than ten (Rₘ<10); and
wherein the three-dimensional structure is configured to generate power and heat when carried with Earth's rotation through Earth's axially symmetric non-rotating magnetic field.

27. The system of claim 26, wherein the at least one device comprises a solid-state device.

28. The system of claim 26, wherein the at least one device comprises a non-solid-state device.

29. The system of claim 26, wherein the three-dimensional structure of the at least one power-generating device comprises a cylindrical shell having an inner radius a and outer radius b.

30. The system of claim 29, wherein a ratio of the outer radii to the inner radii is between 1-10⁶.

31. The system of claim 18, wherein the three-dimensional structure comprises a cylindrical shell having an inner radius a and outer radius b.

32. The system of claim 31, wherein a ratio of the outer radii to the inner radii is between 1-10⁶.

33. The system of claim 18, wherein a relative magnetic permeability of the device is between 1 and 10⁸.

34. The system of claim 18, wherein an electrical conductivity of the device is between 10⁻³ and 10⁸ S m⁻¹.

35. The system of claim 18, wherein the conductive material comprises a non-homogeneous structure including:
a first component comprising a magnetically permeable material having a topology that alters Earth's magnetic field such that curl (v×B)≠0, where v is Earth's velocity of rotation and B derives from the component of Earth's magnetic flux density symmetric about Earth's axis of rotation; and
a second component material having a magnetic Reynolds number less than ten (Rₘ<10).

36. The system of claim 35, wherein the second component material comprises a coating on the three-dimensional structure.

37. The system of claim 35, wherein the second component material comprises a wrapper disposed around the first component.

38. The system of claim 35, wherein the first component comprises a soft-magnetic powder made of iron with other materials, including possibly insulating materials.

39. The system of claim 18, wherein the conductive material comprises at least one of MnZn, NiZn or other ferrite, a Mu-Metal, iron, nickel, an alloy of magnetically permeable metals, such as steel, or a soft-magnetic powder made of iron with other materials, including possibly insulating materials.

40. The system of claim 18, wherein the three-dimensional structure is oriented orthogonal to the Earth's magnetic field component that is symmetric about Earth's rotation axis.

41. The system of claim 18, wherein the three-dimensional structure is disposed greater than 100 km from Earth's surface.

42. The system of claim 18, wherein the three-dimensional structure is disposed underneath or at the surface of Earth's oceans or other body of water, or underground.

43. The system of claim 18, further comprising a third component, wherein the third component comprises an additional magnetically permeable material configured to channel Earth's magnetic field.

44. The system of claim 18, further comprising a metallic material embedded into the three-dimensional structure, wherein the metallic material forms a conducting path.
